(19) United States
(12) Patent Application Publication
(10) Pub. No.: US 2017/0109618 A1
(43) Pub. Date: Apr. 20, 2017

(54) Content Distribution System

(71) Applicant: Oread Group, LLC, Overland Park, KS (US)

(72) Inventor: Dale Russell Knoop, Leawood, KS (US)

(73) Assignee: Oread Group, LLC

(21) Appl. No.: 15/269,018

(22) Filed: Sep. 19, 2016

Related U.S. Application Data
(60) Provisional application No. 62/241,515, filed on Oct. 14, 2015.

(51) Int. Cl. G06K 19/06; G06K 7/14

(52) U.S. Cl. CPC G06K 19/06037; G06K 7/1417; G06K 19/06112; G06K 19/06103; G06Q 30/0267

(57) ABSTRACT

A content distribution system which utilizes a generated code to distribute related content to a user device. The content distribution system generally includes a user device and a central server which are communicatively interconnected via a communication network. The central server generates a code comprising at least one element in a particular visual arrangement. The generated code is related to content which may be stored on the central server, or may be stored on a content server to which the user device may connect. The user device will transmit a code to the central server. The central server identifies the code as relating to the content and either transmits the content directly to the user device, directs the user device to connect to the content server to retrieve the content, or directs the content server to transmit the content to the user device.

### CROSS REFERENCE TO RELATED APPLICATIONS

I hereby claim benefit under Title 35, United States Code, Section 119(e) of U.S. provisional patent application Ser. No. 62/241,515 filed Oct. 14, 2015. The 62/241,515 application is currently pending. The 62/241,515 application is hereby incorporated by reference into this application.

### STATEMENT REGARDING FEDERALLY SPONSORED RESEARCH OR DEVELOPMENT

Not applicable to this application.

### BACKGROUND

Field

Example embodiments in general relate to a content distribution system which utilizes a generated code to distribute related content to a user device.

Related Art

Any discussion of the related art throughout the specification should in no way be considered as an admission that such related art is widely known or forms part of common general knowledge in the field.

Mobile computing devices have gradually become ubiquitous and a part of daily life. Users of smartphones and tablets have access to a portable device that is capable of communicating with others, capable of executing applications, and capable of sending and receiving information to other devices. In one example, people may use their smartphones and tablets while simultaneously viewing content on television and/or media distributed to a network appliance that can receive digital data from sources and stream the digital data to a display (e.g., Apple TV, Roku).

Content creators and advertisers have a difficult time connecting with users of mobile computing devices. Providing content and advertisements to mobile computing devices presents a challenge. Content creators and advertisers have attempted to use Quick Response (QR) Codes, e.g., two-dimensional barcodes, to distribute content and advertisement information to users of mobile computing devices. QR codes are printed in print media and business cards, displayed on display devices, painted onto buildings, provided on posters at bus stops, included in advertisements on train station walls, and displayed in other locations. Typically, a mobile computing device is used to scan the QR code by photographing the QR code. After the mobile computing device photographs the QR code, the mobile computing device may receive resources from a uniform resource locator (URL) or uniform resource identifier (URI) associated with the QR code. Content creators and advertisers have also encouraged users of mobile computing devices to send text messages to a particular number to receive text messages that may provide announcements about new products, coupons, and discounts.

While QR codes provide a way for advertisers and content creators to connect with consumers, they can be used to transmit malicious code, distribute malware, or even be used to send unauthorized text messages. Advertisers and content creators expect users to go through the trouble of scanning or taking a photograph of the QR code. Many users do not know how to scan or take a photograph of the QR code and many other users could not be bothered to take the photograph of the QR code. In addition, content creators and advertisers encouraging use of text messaging invite the fear of spam messages.

### SUMMARY

Briefly described, and according to one embodiment, aspects of the present disclosure generally relate to methods and systems for providing content. In one aspect, a user enters a code having a particular visual arrangement into a mobile computing device, transmits the code having the particular visual arrangement to a central server, and receives content associated with the code having the particular visual arrangement at the mobile computing device. The server receives the code having the particular visual arrangement from the mobile computing device, determines content associated with the code having the particular arrangement and/or advertisement information associated with the code having the particular arrangement, and transmits a reference to the content associated with the code having the particular arrangement and the advertisement information associated with the code having the particular visual arrangement to the mobile computing device. As an example, the server receives a URL from an administrator computing device, generates a code having a particular visual arrangement, and associates the code having the particular visual arrangement with the URL. The URL may be associated with an advertisement for a new product or an upcoming promotion.

In one aspect, a content distribution system includes one or more processors to receive a code having a particular visual arrangement from a mobile computing device, query a database for the code having the particular visual arrangement and determine a reference to content and a reference to an advertisement, and transmit the reference to the content and the reference to the advertisement to the mobile computing device.

These and other aspects, features, and benefits of the present disclosure will become apparent from the following detailed written description of the preferred embodiments and aspects taken in conjunction with the following drawings, although variations and modifications thereto may be effected without departing from the spirit and scope of the novel concepts of the disclosure.

There has thus been outlined, rather broadly, some of the features of the content distribution system in order that the detailed description thereof may be better understood, and in order that the present contribution to the art may be better appreciated. There are additional features of the content distribution system that will be described hereinafter and that will form the subject matter of the claims appended hereto. In this respect, before explaining at least one embodiment of the content distribution system in detail, it is to be understood that the content distribution system is not limited in its application to the details of construction or to the arrangements of the components set forth in the following description or illustrated in the drawings. The content distribution system is capable of other embodiments and of being practiced and carried out in various ways. Also, it is to be understood that the phraseology and terminology employed herein are for the purpose of the description and should not be regarded as limiting.

### BRIEF DESCRIPTION OF THE DRAWINGS

Example embodiments will become more fully understood from the detailed description given herein below and the accompanying drawings, wherein like elements are represented by like reference characters, which are given by way of illustration only and thus are not limitative of the example embodiments herein.

FIG. 1 is a block diagram of a content distribution system in accordance with a first example embodiment.

FIG. 2 is a block diagram of a content distribution system in accordance with a second example embodiment.

FIG. 3 is a block diagram of a content distribution system in accordance with a third example embodiment.

FIG. 4 is an example architecture diagram of the content distribution system according to an example embodiment.

FIG. 5a is a frontal view of a user device displaying an interface in accordance with a first example embodiment.

FIG. 5b is a frontal view of a user device displaying an interface in accordance with a second example embodiment.

FIG. 5c is a frontal view of a user device displaying an interface in accordance with a third example embodiment.

FIG. 5d is a frontal view of a user device displaying an interface in accordance with a fourth example embodiment.

FIG. 5e is a frontal view of a user device displaying an interface in accordance with a fifth example embodiment.

FIG. 5f is a frontal view of a user device displaying an interface in accordance with a sixth example embodiment.

FIG. 5g is a frontal view of a user device displaying an interface in accordance with a seventh example embodiment.

FIG. 6a is a frontal view of a user device illustrating entry of a code in an interface in accordance with a first example embodiment.

FIG. 6b is a frontal view of a user device illustrating entry of a code in an interface in accordance with a second example embodiment.

FIG. 6c is a frontal view of a user device illustrating entry of a code in an interface in accordance with a third example embodiment.

FIG. 6d is a frontal view of a user device illustrating entry of a code in an interface in accordance with a fourth example embodiment.

FIG. 7a is a frontal view of a user device illustrating a first exemplary code entered in an exemplary interface.

FIG. 7b is a frontal view of a user device illustrating a second exemplary code entered in an exemplary interface.

FIG. 7c is a frontal view of a user device illustrating a third exemplary code entered in an exemplary interface.

FIG. 7d is a frontal view of a user device illustrating a fourth exemplary code entered in an exemplary interface.

FIG. 7e is a frontal view of a user device illustrating a fifth exemplary code entered in an exemplary interface.

FIG. 7f is a frontal view of a user device illustrating a sixth exemplary code entered in an exemplary interface.

FIG. 7g is a frontal view of a user device illustrating a seventh exemplary code entered in an exemplary interface.

FIG. 7h is a frontal view of a user device illustrating an eighth exemplary code entered in an exemplary interface.

FIG. 8a is a frontal view of a user device entering a code in a first specified manner and receiving a first type of content.

FIG. 8b is a frontal view of a user device entering a code in a second specified manner and receiving a second type of content.

FIG. 8c is a frontal view of a user device entering a code in a third specified manner and receiving a third type of content.

FIG. 9a is a frontal view of a user device entering a code in a first specified manner and receiving a first type of content.

FIG. 9b is a frontal view of a user device entering a code in a second specified manner and receiving a second type of content.

FIG. 9c is a frontal view of a user device entering a code in a second specified manner and receiving a second type of content.

FIG. 10a is a frontal view of a user device illustrating an exemplary code having first exemplary code elements entered in an exemplary interface.

FIG. 10b is a frontal view of a user device illustrating an exemplary code having second exemplary code elements entered in an exemplary interface.

FIG. 10c is a frontal view of a user device illustrating an exemplary code having third exemplary code elements entered in an exemplary interface.

FIG. 10d is a frontal view of a user device illustrating an exemplary code having fourth exemplary code elements entered in an exemplary interface.

FIG. 10e is a frontal view of a user device illustrating an exemplary code having fifth exemplary code elements entered in an exemplary interface.

FIG. 10f is a frontal view of a user device illustrating an exemplary code having sixth exemplary code elements entered in an exemplary interface.

FIG. 11 is a view illustrating a process of entering a first exemplary code in a user device.

FIG. 12 is a view illustrating a process of entering a second exemplary code in a user device.

FIG. 13 is a perspective view of an exemplary user device comprising a laptop in accordance with an example embodiment.

FIG. 14 is a perspective view of a user viewing a code and entering the code in a user device to receive content.

FIG. 15 is a perspective view of a user viewing a code and entering the code in a user device to receive content.

FIG. 16 is a perspective view of a user viewing a code and entering the code in a user device to receive content.

FIG. 17a is a frontal view of a user device illustrating entry of a code in a first exemplary interface including a pattern selector.

FIG. 17b is a frontal view of a user device illustrating entry of a code in a second exemplary interface including a pattern selector.

FIG. 17c is a frontal view of a user device illustrating entry of a code in a third exemplary interface including a pattern selector.

FIG. 18a is a frontal view of a user device illustrating an interface incorporating a company logo.

FIG. 18b is a frontal view of a user device illustrating entry of a code into an interface incorporating a company logo.

FIG. 19 is a flowchart illustrating an exemplary method of generating a code and transmitting content to a user device.

FIG. 20 is a flowchart illustrating code generation relating to a destination for content from a provider.

FIG. 21 is a flowchart illustrating code generation relating to content from a provider.

FIG. 22 is a flowchart illustrating code entry and transmission of content to a user device.

FIG. 23 is a flowchart illustrating code entry in an interface and transmission of related content to a user device.

FIG. 24 is an exemplary view of an administrator interface in accordance with an example embodiment.

FIG. 25 is an exemplary view of a user interface in accordance with an example embodiment.

### DETAILED DESCRIPTION

### A. Overview

An example content distribution system 10 generally comprises a user device 20 and a central server 30 which are communicatively interconnected via a communication network 14. The central server 30 generates a code 80 comprising at least one element 82 in a particular visual arrangement. The generated code 80 is related to content 90 which may be stored on the central server 30, or may be stored on a content server 50 to which the user device 20 may connect. The user device 20 will transmit a code 80 to the central server 30. The central server 30 identifies the code 80 as relating to the content 90 and either transmits the content 90 directly to the user device 20, directs the user device 20 to connect to the content server 50 to retrieve the content 90, or directs the content server 50 to transmit the content 90 to the user device 20.

Also disclosed is a method of transmitting content 90 from a central server 30 to a user device 20, comprising the step of receiving the code 80 from the user device 20 by the central server 30. The code 80 comprises at least one element 82 having a visual arrangement. The method further comprises identifying the content 90 related to the code 80 received from the user device 20 by the central server 30 and transmitting the content 90 related to the code 80 from the central server 30 to the user device 20.

In some embodiments, the central server 30 will also generate the code 80 and relate it to content 90 as part of the method. In such an embodiment, the above steps are performed in addition to the step of receiving the content 90 from a content provider to be transmitted to the user device 20 and generating a code 80 related to the content 90.

Also disclosed is a method of receiving content 90 on a user device 20, comprising the step of displaying an interface 70 on the user device 20. The interface 70 may comprise a plurality of entry fields 72 arranged in a visual pattern 75. The method of receiving content 90 also comprises the step of receiving the code 80 comprising at least one element 82 to be entered in the interface 70 in a specified manner (the specified manner may include what element 82 to use, which entry field 72 to enter the element 82 into, and/or a sequence by which the elements 82 of the code 80 should be entered). The method further comprises entering the code 80 into the interface 70 in the specified manner by the user and receiving content 90 related to the code 80 on the user device 20.

### B. Content Distribution System

The various systems, devices, and/or servers described herein may communicate and coordinate their actions by passing messages over a communication network 14. The communication network 14 can be one or more of the Internet, an intranet, a cellular communications network, a WiFi network, a packet network, or another wired or wireless communication network. As an example, the systems, devices, and/or servers communicate data in packets, messages, or other communications using a common protocol, e.g., Hypertext Transfer Protocol (HTTP) and/or Hypertext Transfer Protocol Secure (HTTPS). As an example, the content distribution system 10 may be a cloud-based computer system or a distributed computer system.

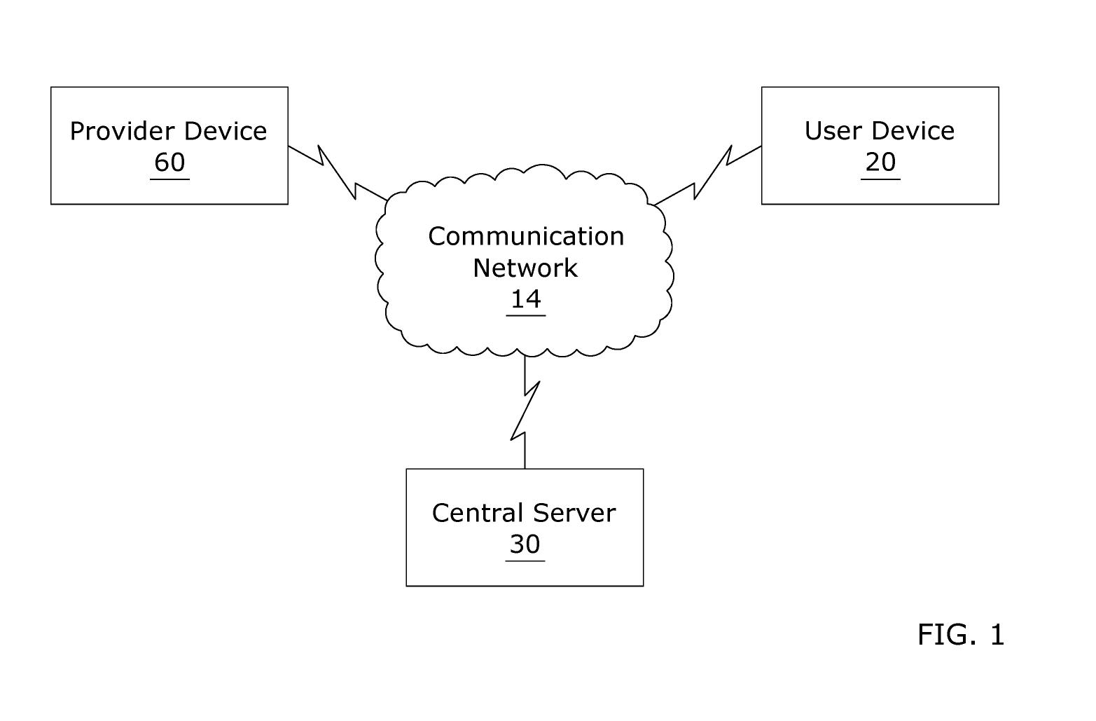

FIG. 1 illustrates a first exemplary block diagram of a content distribution system 10 according to an example embodiment. As shown in FIG. 1, this particular example embodiment of the content distribution system 10 comprises a user device 20, a central server 30, and a provider device 60. The user device 20, central server 30, and provider device 60 may comprise any computing device or system of computing devices, which perform the various functions described herein.

In the exemplary embodiment of FIG. 1, the user device 20, central server 30, and provider device 60 are communicatively interconnected via a communication network 14. It should be appreciated that the user device 20, central server 30, and provider device 60 need not necessarily all be connected simultaneously. For example, the provider device 60 may communicatively interconnect with the central server 30 to request code generation at a first time, and then the user device 20 may communicatively interconnect with the central server 30 to receive content 90 related to the generated code 80 at a second time when the provider device 60 is not connected to the central server 30.

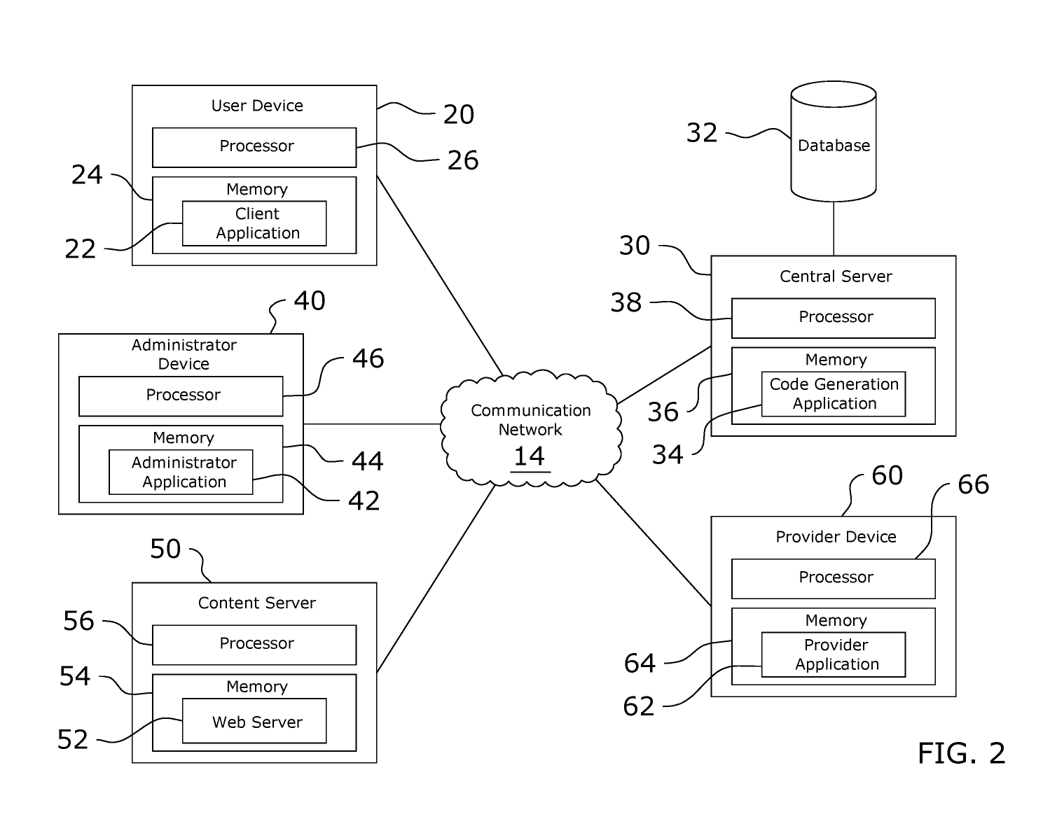

FIG. 2 illustrates a block diagram of another exemplary embodiment of a content distribution system 10 according to an example embodiment. According to an aspect of the present disclosure, the content distribution system 10 includes one or more user devices 20. The content distribution system 10 further comprises one or more administrator computing devices 40, one or more content servers 50, one or more central servers 30, one or more databases 32, one or more provider devices 60, and a communication network 14.

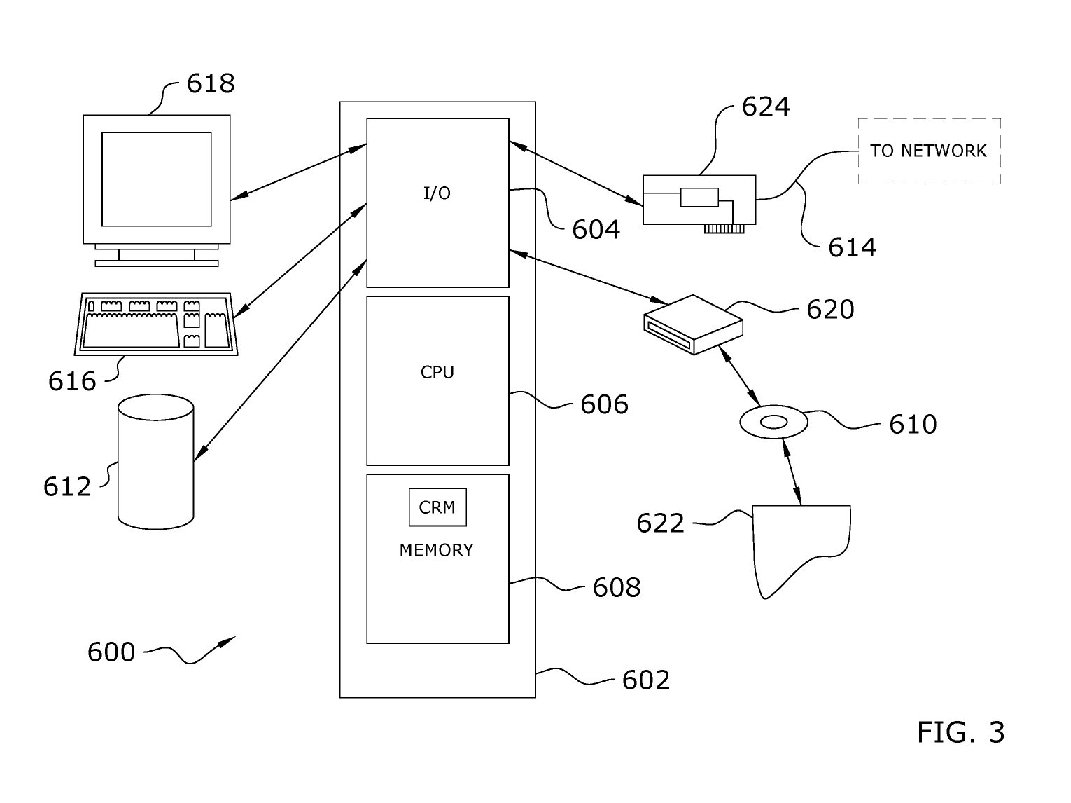

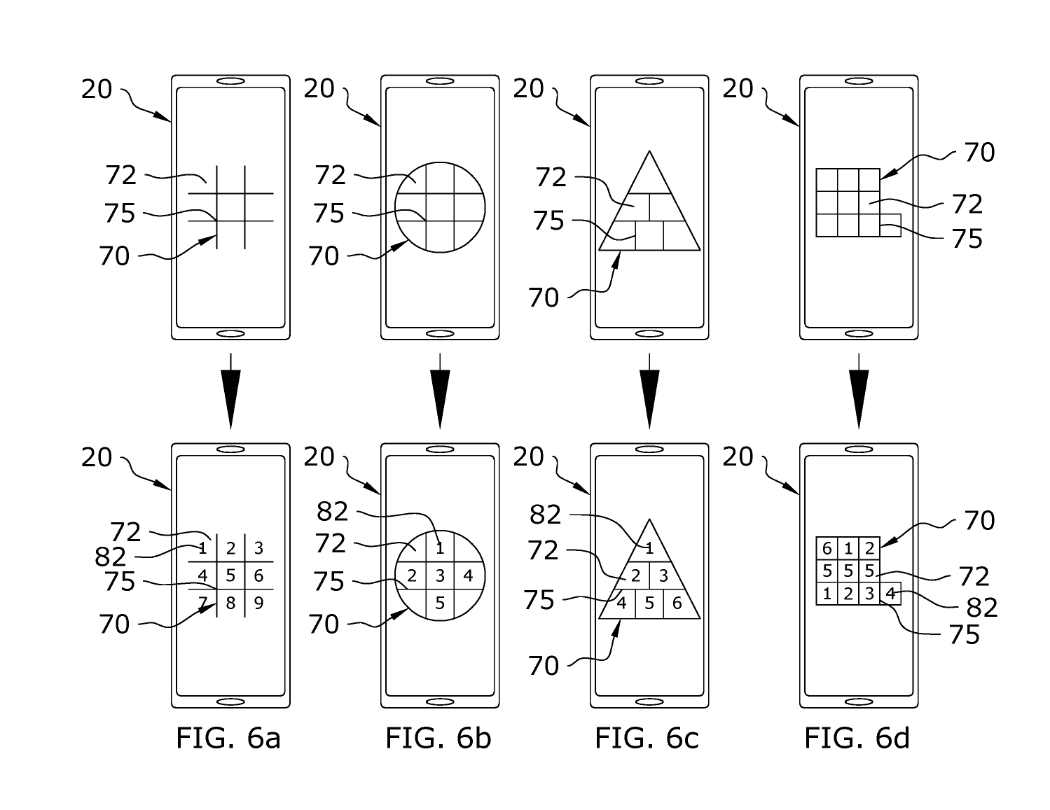

FIG. 3 illustrates an example computing system 600 that may implement various systems, such as the user device 20, the administrator device 40, the content server 50, the central server 30, the provider device 60, and methods discussed herein, such as process 200. A general purpose computer system 600 is capable of executing a computer program product to execute a computer process. Data and program files may be input to the computer system 600, which reads the files and executes the programs therein such as the client application 22, the administrator application 42, the web server 52, the code generation application 34, and the provider application 62. Some of the elements of a general purpose computer system 600 are shown in FIG. 6 wherein a processor 602 is shown having an input/output (I/O) section 604, a central processing unit (CPU) 606, and a memory section 608. There may be one or more processors 602, such that the processor 602 of the computer system 600 comprises a single central-processing unit 606, or a plurality of processing units, commonly referred to as a parallel processing environment. The computer system 600 may be a conventional computer, a server, a distributed computer, or any other type of computer, such as one or more external computers made available via a cloud computing architecture. The presently described technology is optionally implemented in software devices loaded in memory 608, stored on a configured DVD/CD-ROM 610 or storage unit 612, and/or communicated via a wired or wireless network link 614, thereby transforming the computer system 600 in FIG. 3 to a special purpose machine for implementing the described operations.

The memory section 608 may be volatile media, nonvolatile media, removable media, non-removable media, and/or other media or mediums that can be accessed by a general purpose or special purpose computing device. For example, the memory section 608 may include non-transitory computer storage media and communication media. Non-transitory computer storage media further may include volatile, nonvolatile, removable, and/or non-removable media implemented in a method or technology for the storage (and retrieval) of information, such as computer/machine-readable/executable instructions, data and data structures, engines, program modules, and/or other data. Communication media may, for example, embody computer/machine-readable/executable, data structures, program modules, algorithms, and/or other data. The communication media may also include an information delivery technology. The communication media may include wired and/or wireless connections and technologies and be used to transmit and/or receive wired and/or wireless communications.

The I/O section 604 is connected to one or more user-interface devices (e.g., a keyboard 616 and a display unit 618), a disc storage unit 612, and a disc drive unit 620. Generally, the disc drive unit 620 is a DVD/CD-ROM drive unit capable of reading the DVD/CD-ROM medium 610, which typically contains programs and data 622. Computer program products containing mechanisms to effectuate the systems and methods in accordance with the presently described technology may reside in the memory section 604, on a disc storage unit 612, on the DVD/CD-ROM medium 610 of the computer system 600, or on external storage devices made available via a cloud computing architecture with such computer program products, including one or more database management products, web server products, application server products, and/or other additional software components. Alternatively, a disc drive unit 620 may be replaced or supplemented by a floppy drive unit, a tape drive unit, or other storage medium drive unit. The network adapter 624 is capable of connecting the computer system 600 to a network via the network link 614, through which the computer system 600 can receive instructions and data. Examples of such systems include personal computers, Intel or PowerPC-based computing systems, AMD-based computing systems and other systems running a Windows-based, a UNIX-based, or other operating system. It should be understood that computing systems may also embody devices such as Personal Digital Assistants (PDAs), mobile phones, tablets or slates, multimedia consoles, gaming consoles, set top boxes, etc.

When used in a LAN-networking environment, the computer system 600 is connected (by wired connection and/or wirelessly) to a local network through the network interface or adapter 624, which is one type of communications device. When used in a WAN-networking environment, the computer system 600 typically includes a modem, a network adapter, or any other type of communications device for establishing communications over the wide area network. In a networked environment, program modules depicted relative to the computer system 600 or portions thereof, may be stored in a remote memory storage device. It is appreciated that the network connections shown are examples of communications devices for and other means of establishing a communications link between the computers may be used.

In an example implementation, source code executed by the user device 20, the administrator computing device 40, the content server 50, the central server 30, and the provider device 60, a plurality of internal and external databases, source databases, and/or cached data on servers are stored in memory 24 of the user device 20, memory 44 of the administrator computing device 40, memory 54 of the content server 50, memory 36 of the central server 30, memory 64 of the provider device 60, or other storage systems, such as the disk storage unit 612 or the DVD/CD-ROM medium 610, and/or other external storage devices made available and accessible via a network architecture. The source code executed by the user device 20, the administrator computing device 40, the content server 50, the central server 30, and the provider device 60 may be embodied by instructions stored on such storage systems and executed by the processor 602.

Some or all of the operations described herein may be performed by the processor 602, which is hardware. Further, local computing systems, remote data sources and/or services, and other associated logic represent firmware, hardware, and/or software configured to control operations of the content distribution system 10 and/or other components. Such services may be implemented using a general purpose computer and specialized software (such as a server executing service software), a special purpose computing system and specialized software (such as a mobile device or network appliance executing service software), or other computing configurations. In addition, one or more functionalities disclosed herein may be generated by the processor 602 and a user may interact with a Graphical User Interface (GUI) using one or more user-interface devices (e.g., the keyboard 616, the display unit 618, and the user device 604) with some of the data in use directly coming from online sources and data stores. The system set forth in FIG. 6 is but one possible example of a computer system that may employ or be configured in accordance with aspects of the present disclosure.

In the present disclosure, the methods disclosed may be implemented as sets of instructions or software readable by a device. Further, it is understood that the specific order or hierarchy of steps in the methods disclosed are instances of example approaches. Based upon design preferences, it is understood that the specific order or hierarchy of steps in the method can be rearranged while remaining within the disclosed subject matter. The accompanying method claims present elements of the various steps in a sample order, and are not necessarily meant to be limited to the specific order or hierarchy presented.

The described disclosure may be provided as a computer program product, or software, that may include a non-transitory machine-readable medium having stored thereon executable instructions, which may be used to program a computer system (or other electronic devices) to perform a process according to the present disclosure. A non-transitory machine-readable medium includes any mechanism for storing information in a form (e.g., software, processing application) readable by a machine (e.g., a computer). The non-transitory machine-readable medium may include, but is not limited to, magnetic storage medium (e.g., floppy diskette), optical storage medium (e.g., CD-ROM), magneto-optical storage medium, read only memory (ROM), random access memory (RAM), erasable programmable memory (e.g., EPROM and EEPROM), flash memory or other types of medium suitable for storing electronic executable instructions.

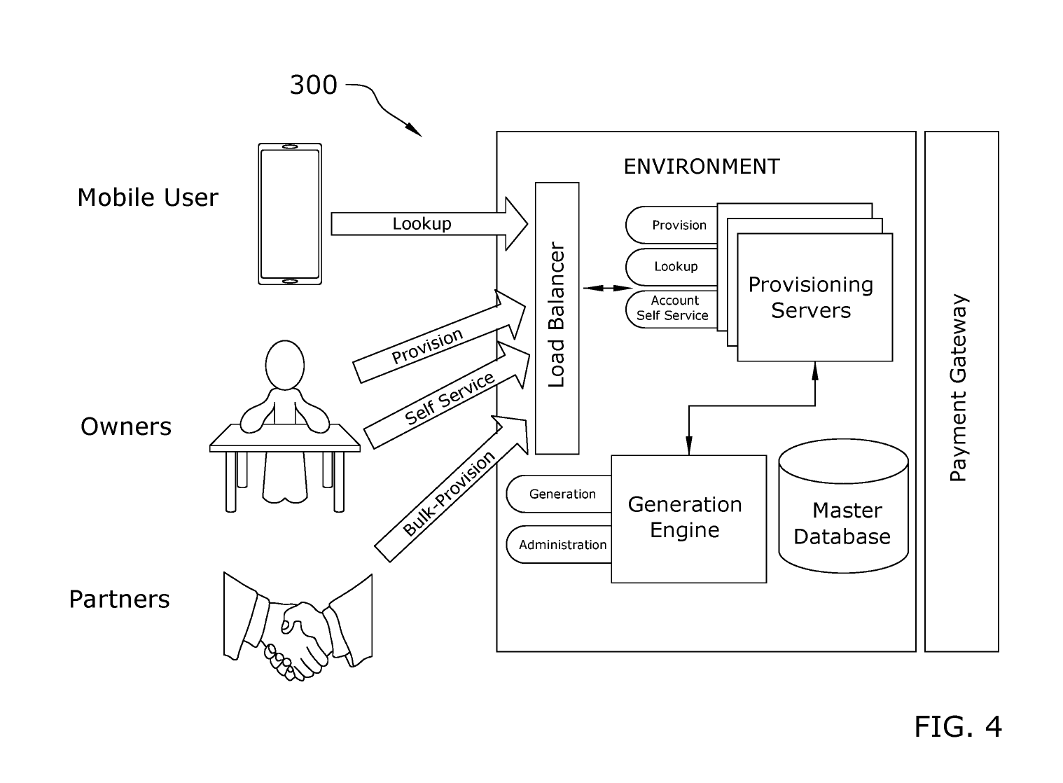

FIG. 4 illustrates an example architecture diagram 300 of the content distribution system 10 according to an example embodiment. This view is merely for illustrative purposes and is no way intended to be limiting on the scope.

i. User Device.

FIG. 2 illustrates a block diagram of the user device 20 according to an example embodiment. The user device 20 may be a computer having one or more processors 26 and memory 24, including but not limited to a laptop, desktop, tablet computer, smartphone, or a dedicated electronic device having a processor and memory. The one or more processors 26 may process machine/computer-readable executable instructions and data, and the memory 24 may store machine/computer-readable executable instructions and data including one or more applications, including a client application 22. The processor 26 and memory 24 are hardware. The memory 24 includes random access memory (RAM) and non-transitory memory, e.g., a non-transitory computer-readable medium such as one or more flash disks or hard drives. The non-transitory memory may include any tangible computer-readable medium including, for example, magnetic and/or optical disks, flash drives, and the like.

The client application 22 may be a component of an application and/or service executable by the user device 20. For example, the client application 22 may be a single unit of deployable executable code. The client application 22 may also be one application and/or a suite of applications for requesting content.

In one embodiment, the client application 22 sends a request comprising a code 80 having a particular visual arrangement to the central server 30 and receives a response from the central server 30, the response comprising a reference to a destination and optional advertisement content. As an example, the reference to the destination may be a URL or a URI that refers to a particular internet protocol (IP) address served by the content server 50.

The client application 22 may retrieve resources at the destination. As an example, the client application 22 may display a webview and retrieve an application available for download (e.g., an app), a web-based coupon, a web page (e.g., a product splash page), a social media page, automatically complete a web-based form based on information available to the client application 22, make a purchase, complete a web-based survey, or enter a contest, among other destinations.

The client application 22 may be a web-based application viewed in a browser on the user device 20 and/or a native client application 22 executed by the user device 20. The client application 22 may be downloaded from the Internet and/or digital distribution platforms, e.g., directly from a website, the Mac App Store, the App Store, and/or GOOGLE PLAY™, among others. According to an example embodiment, the client application 22 is an iOS application, an Android application, or a Windows Phone application. According to another example embodiment, the client application 22 is a Windows application, a Mac OS application, a Linux application. It should be appreciated that the client application 22 should not be construed as being limited in any manner by the operating system being run by the user device 20. The client application 22 communicates messages with the central server 30 using the communication network 14.

The user device 20 may further include an optional display and an input device. The display is used to display visual components of the client application 22, such as a user interface. In one example, the display may display a user interface of the client application 22. The display can be a liquid-crystal display, a light-emitting diode display, an organic light-emitting diode display, a touch screen display, an e-ink display, an e-paper display, and other displays.

The input device is used to interact with the client application 22 and may include a mouse, a keyboard, a trackpad, and/or the like. The input device may be included within the display if the display is a touch screen display. The input device allows a user of the user device 20 to manipulate and interact with the user interface of the client application 22.

ii. Administrator Device.

FIG. 2 illustrates a block diagram of the administrator device 40 according to an example embodiment. According to an aspect of the present disclosure, the administrator device 40 is a computer having one or more processors 46 and memory 44. The administrator device 40 may be, for example, a laptop, desktop, a server, tablet computer, mobile computing device (e.g., a smart phone) or a dedicated electronic device having a processor and memory. The administrator device 40 includes one or more processors 46 to process data and memory 44 to store machine/computer-readable executable instructions and data including an administrator application 42 for transmitting administration information to the central server 30 including one or more information associated with one or more destinations. The processor 46 and memory 44 are hardware. The memory 44 includes non-transitory memory, e.g., random access memory (RAM) and one or more hard disks. The non-transitory memory may include any tangible computer-readable medium including, for example, magnetic and/or optical disks, flash drives, and the like. The data associated with the administrator application 42 may be stored in a structured query language (SQL) server database or another appropriate database management system within memory 44 and/or in the one or more databases 32. Additionally, the memory 44 and/or the databases 32 may also include a dedicated file server having one or more dedicated processors, random access memory (RAM), a Redundant Array of Inexpensive Disks hard drive configuration, an Ethernet interface or other communication interface, and a server-based operating system.

The administrator device 40 may further include an optional display and an input device. The display is used to display visual components of the administrator application 42, such as a user interface. In one example, the display may display a user interface of the administrator application 42. The display can be a liquid-crystal display, a light-emitting diode display, an organic light-emitting diode display, a touch screen display, an e-ink display, an e-paper display, and other displays. The input device is used to interact with the administrator application 42 and may include a mouse, a keyboard, a trackpad, and/or the like. The input device may be included within the display if the display is a touch screen display. The input device allows a user of the administrator device 40 to manipulate and interact with the user interface of the administrator application 42.

According to an example embodiment, the one or more databases 32 may store the administration information. The administration information may include information associated with one or more accounts comprising account information. The account information may include a name, an address, a username, a password, a list of references to destinations served by the content server 50 and/or another server, and payment information, among other information. Each destination may be associated with a code 80 having a particular visual arrangement generated by the central server 30.

iii. Content Server.

FIG. 2 illustrates a block diagram of the content server 50 according to an example embodiment. According to an aspect of the present disclosure, the content server 50 is a computer having one or more processors 56 and memory 54. The content server 50 may be, for example, a laptop, desktop, a server, tablet computer, mobile computing device (e.g., a smart phone) or a dedicated electronic device having a processor and memory. The content server 50 includes one or more processors 56 to process data and memory 54 to store machine/computer-readable executable instructions and data including a web server 52 for distributing resources associated with one or more destinations, e.g., a URL. The processor 56 and memory 54 are hardware. The memory 54 includes non-transitory memory, e.g., random access memory (RAM) and one or more hard disks. The non-transitory memory may include any tangible computer-readable medium including, for example, magnetic and/or optical disks, flash drives, and the like. The data associated with the web server 52 may be stored in a structured query language (SQL) server database or another appropriate database management system within memory 54 and/or in one or more databases associated with the content server 50. Additionally, the memory 54 and/or the databases associated with the web server 52 may also include a dedicated file server having one or more dedicated processors, random access memory (RAM), a Redundant Array of Inexpensive Disks hard drive configuration, an Ethernet interface or other communication interface, and a server-based operating system.

The content server 50 may further include an optional display and an input device. The display is used to display visual components of the web server 52, such as a user interface. In one example, the display may display a user interface of the web server 52. The display can be a liquid-crystal display, a light-emitting diode display, an organic light-emitting diode display, a touch screen display, an e-ink display, an e-paper display, and other displays. The input device is used to interact with the web server 52 and may include a mouse, a keyboard, a trackpad, and/or the like. The input device may be included within the display if the display is a touch screen display. The input device allows a user of the content server 50 to manipulate and interact with the user interface of the web server 52.

iv. Central Server.

FIG. 2 illustrates a block diagram of the central server 30 according to an example embodiment. According to an aspect of the present disclosure, the central server 30 is a computer having one or more processors 38 and memory 36. The central server 30 may be, for example, a laptop, desktop, a server, tablet computer, mobile computing device (e.g., a smart phone) or a dedicated electronic device having a processor and memory. The central server 30 includes one or more processors 38 to process data and memory 36 to store machine/computer-readable executable instructions and data including a code generation application 34 for receiving a reference to content comprising a destination, e.g., a URL, generating an associated code, associating the code with the reference to the content, and storing the reference to the content and a representation of the code in the database 32.

The code may be a code 80 having a particular visual arrangement. The processor 38 and memory 36 are hardware. The memory 36 includes non-transitory memory, e.g., random access memory (RAM) and one or more hard disks. The non-transitory memory may include any tangible computer-readable medium including, for example, magnetic and/or optical disks, flash drives, and the like. The data associated with the code generation application 34 may be stored in a structured query language (SQL) server database or another appropriate database management system within memory 36 and/or in the one or more databases 32. Additionally, the memory 36 and/or the databases associated with the central server 30 may also include a dedicated file server having one or more dedicated processors, random access memory (RAM), a Redundant Array of Inexpensive Disks hard drive configuration, an Ethernet interface or other communication interface, and a server-based operating system.

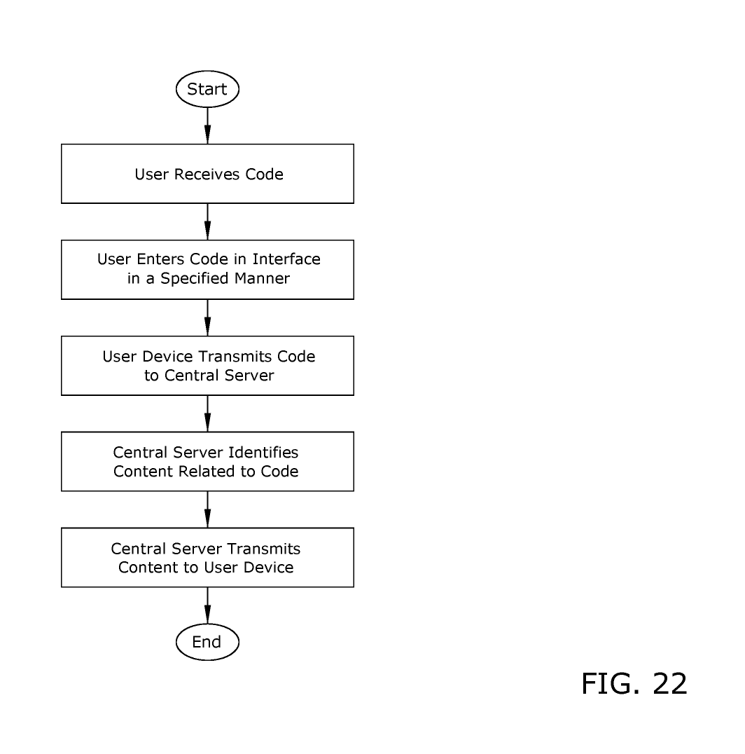

The central server 30 may further include an optional display and an input device. The display is used to display visual components of the code generation application 34, such as a user interface. In one example, the display may display a user interface of the code generation application 34. An example of the user interface of the code generation application is shown in FIG. 22. The display can be a liquid-crystal display, a light-emitting diode display, an organic light-emitting diode display, a touch screen display, an e-ink display, an e-paper display, and other displays.

The input device is used to interact with the code generation application 34 and may include a mouse, a keyboard, a trackpad, and/or the like. The input device may be included within the display if the display is a touch screen display. The input device allows a user of the central server 30 to manipulate and interact with the user interface of the code generation application 138.

According to an example embodiment, the one or more databases 32 may store the representations of the codes having the particular visual arrangement and associate the representations of the codes having the particular visual arrangement with the references to destinations.

v. Provider Device.

FIG. 2 illustrates a block diagram of the provider device 60 according to an example embodiment. According to an aspect of the present disclosure, the provider device 60 is a computer having one or more processors 66 and memory 64. The provider device 60 may be, for example, a laptop, desktop, a server, tablet computer, mobile computing device (e.g., a smart phone) or a dedicated electronic device having a processor and memory. The provider device 60 includes one or more processors 66 to process data and memory 64 to store machine/computer-readable executable instructions and data including an provider application 62 for transmitting advertiser information to the central server 30. The processor 66 and memory 64 are hardware.

The memory 64 includes non-transitory memory, e.g., random access memory (RAM) and one or more hard disks. The non-transitory memory may include any tangible computer-readable medium including, for example, magnetic and/or optical disks, flash drives, and the like. The data associated with the provider application 62 may be stored in a structured query language (SQL) server database or another appropriate database management system within memory 64 and/or in the one or more databases 32. Additionally, the memory 64 and/or the databases 32 may also include a dedicated file server having one or more dedicated processors, random access memory (RAM), a Redundant Array of Inexpensive Disks hard drive configuration, an Ethernet interface or other communication interface, and a server-based operating system.

The provider device 60 may further include an optional display and an input device. The display is used to display visual components of the provider application 62, such as a user interface. In one example, the display may display a user interface of the provider application 62. The display can be a liquid-crystal display, a light-emitting diode display, an organic light-emitting diode display, a touch screen display, an e-ink display, an e-paper display, and other displays. The input device is used to interact with the provider application 62 and may include a mouse, a keyboard, a trackpad, and/or the like. The input device may be included within the display if the display is a touch screen display. The input device allows a user of the provider device 60 to manipulate and interact with the user interface of the provider application 62.

### C. Client Application and Interface

In one embodiment, a user may configure the user device 20. The user may download and/or install the client application 22 in memory 24 on the user device 20. In an example, the user downloads and installs the client application 22 on an iOS-based or Android-based smart phone.

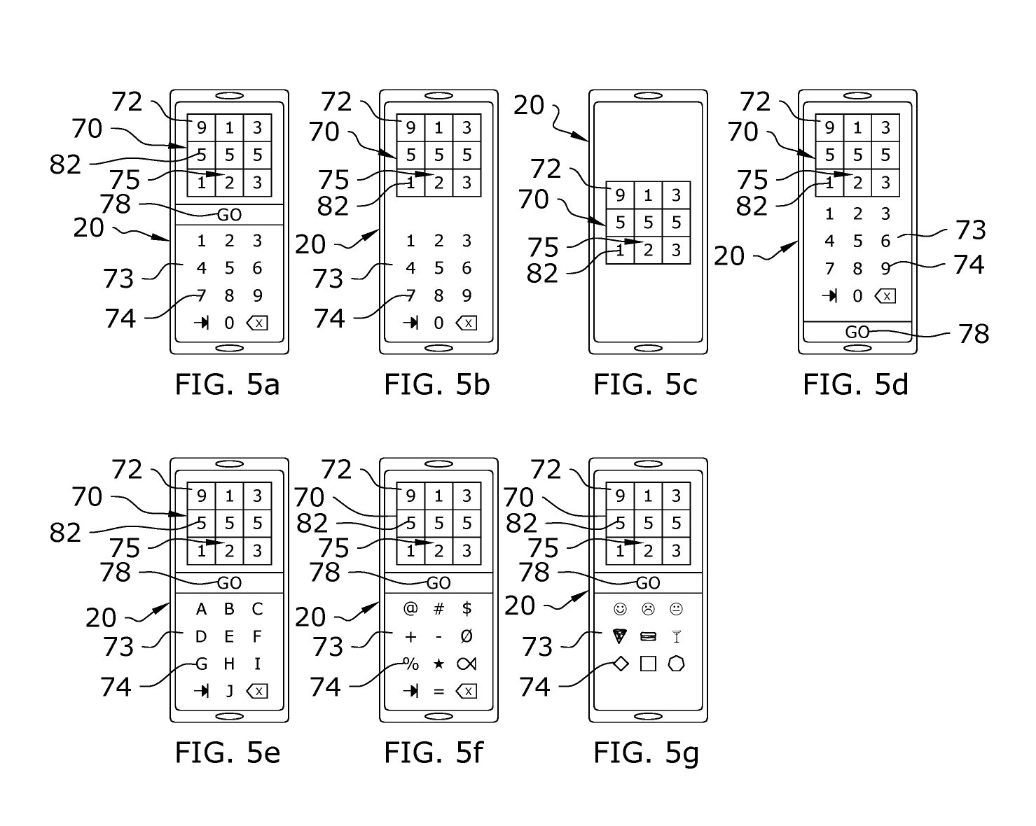

The client application 22 may generate an interface such as a user interface 70 on the display of the user device 20. The user interface 70 may include information associated with the requested resources, one or more entry fields 72 for entering one or more codes 80 having a particular visual arrangement, and an advertiser user interface element for displaying one or more advertisements associated with the requested resources. The user interface 70 may include a button 78 (such as a “GO” button as shown in the figures) or other user interface elements for sending an entered code 80 having the particular visual arrangement to the central server 30. An example of the user interface is shown in at least FIGS. 5a-5g, 6a-6d and 25.

FIGS. 6a-6d illustrate exemplary interfaces 70 which may be displayed on a user device 20. It should be appreciated that the exemplary interfaces 70 shown in the figures and described herein are merely for exemplary purposes and should not be construed as limiting on the scope of the invention. Any number of interface 70 configurations could be utilized for entry of the code 80.

It should be appreciated that the interface 70 may comprise a plurality of entry fields 72 arranged in a visual pattern 75. The entry fields 72 comprise areas in the interface 70 wherein elements 82 of the code 80 may be entered. In some embodiments, the specific entry field 72 in which a specific element 82 is entered is specific to the code 80. In other embodiments, the elements 82 of the code 80 may be entered in any entry field 72.

The entry fields 72 may be identified on the interface 70 in various manners, including by providing a grid-pattern of entry fields 72. It should be appreciated that the shape, size, number of, configuration of, and orientation of the entry fields 72 of the interface 70 and the visual pattern 75 created by the entry fields 72 may vary in different embodiments. The entry fields 72 may be arranged to form a visual pattern 75 of an array, such as a multi-dimensional array including a matrix. While the figures illustrate exemplary entry fields 72 and visual patterns 75, there are merely meant for illustrative purposes and should not be construed as limiting on the scope.

FIG. 6a illustrates an exemplary interface 70 having a plurality of entry fields 72 arranged in a visual pattern 75 having a square-shape representing a 3×3 matrix. In this exemplary interface 70, there are nine entry fields 72 available for entering a code 80. FIG. 6a illustrates an exemplary code 80 entered in the entry fields 72 of the exemplary interface 70 with the square-shaped visual pattern 75.

FIG. 6b illustrates another exemplary interface 70 having a plurality of entry fields 72 arranged in a visual pattern 75. In this example embodiment, the visual pattern 75 comprises a circle-shape with the entry fields 72 being positioned within the circle. The number of entry fields 72 within the circle-shaped visual pattern 75 may vary and should not be construed as limited by the configuration shown in the exemplary figure. FIG. 6b illustrates an exemplary code 80 entered in the entry fields 72 of the exemplary interface 70 with the circle-shaped visual pattern 75.

FIG. 6c illustrates yet another exemplary interface 70 having a plurality of entry fields 72 arranged in a visual pattern 75. In this example embodiment, the visual pattern 75 comprises a triangle-shape with the entry fields 72 being positioned within the triangle. The number of entry fields 72 within the triangular-shaped visual pattern 75 may vary and should not be construed as limited by the configuration shown in the exemplary figure. FIG. 6c illustrates an exemplary code 80 entered in the entry fields 72 of the exemplary interface 70 with the triangular-shaped visual pattern 75.

FIG. 6d illustrates another exemplary interface 70 having a plurality of entry fields 72 arranged in a visual pattern 75. In this case, the visual pattern 75 comprises a square-shape with an extra entry field 72 extending out from the lower-right side of the square. This extra entry field 72 allows entry of a tenth code element 82. This particular exemplary interface 70 is well-suited for entry of a code 80 that is based on a telephone number. FIG. 6d illustrates an exemplary code 80 comprising a telephone number that has been entered in the entry fields 72 of the exemplary interface 70 having the above-described visual pattern 75.

As shown in FIGS. 5a-g, the interface 70 may vary widely in application. The interface 70 may include a keypad 73 containing a plurality of entry elements 74. By selecting one of the entry elements 74, such as with one's finger or by using a mouse or other input device, a user may enter the selected entry element 74 within a particular entry field 72. The entry field 72 into which the entry element 74 will be entered may be selected in a number of ways, including by using the backspace or selector entry elements 74 of the keypad 73.

FIG. 5c illustrates an interface 70 which does not include a keypad 73. This type of interface 70 may be utilized on user devices 20 which support voice commands. Thus, audio instructions vocally spoken aloud to the user device 70 may be used to enter the code elements 82 into the entry fields 72.

It should also be appreciated that the entry elements 74 of the keypad 73 will vary in different embodiments. FIGS. 5a, 5b, 5d illustrate an interface 70 having a standard keypad 73 containing a plurality of entry elements 74 comprising numbers, a backspace, and a selector. FIG. 5e illustrates a keypad 73 having letters instead of numbers. This type of keypad 73 may be utilized to enter codes 80 that include letters. FIGS. 5f and 5g illustrate key pads 73 in which symbols are utilized for the entry elements 74. In FIG. 5f, the entry elements 74 comprise characters such as an ampersand, hashtag, percentage sign, dollar sign, and the like. FIG. 5g illustrates entry elements 74 comprising visual representations of faces (typically referred to as “emojis”), different types of foods, or different shapes.

As shown in FIGS. 5a, 5d, 5e, 5f, and 5g, the interface 70 may include a button 78 such as a “GO” button 78 that may be selected upon completion of entering the code 80 in the entry fields 72. The shape, placement, and configuration of the button 78 may vary and, in some embodiments, the button 78 may be omitted entirely. FIGS. 5b, 5c illustrate interfaces 70 without a button 78. FIGS. 5a, 5e, 5f, 5g illustrate interfaces 70 wherein the button 78 is positioned between the visual pattern 75 of the entry fields 72 and the keypad 73. FIG. 5d illustrates an interface 70 in which the button 78 is positioned beneath the keypad 73.

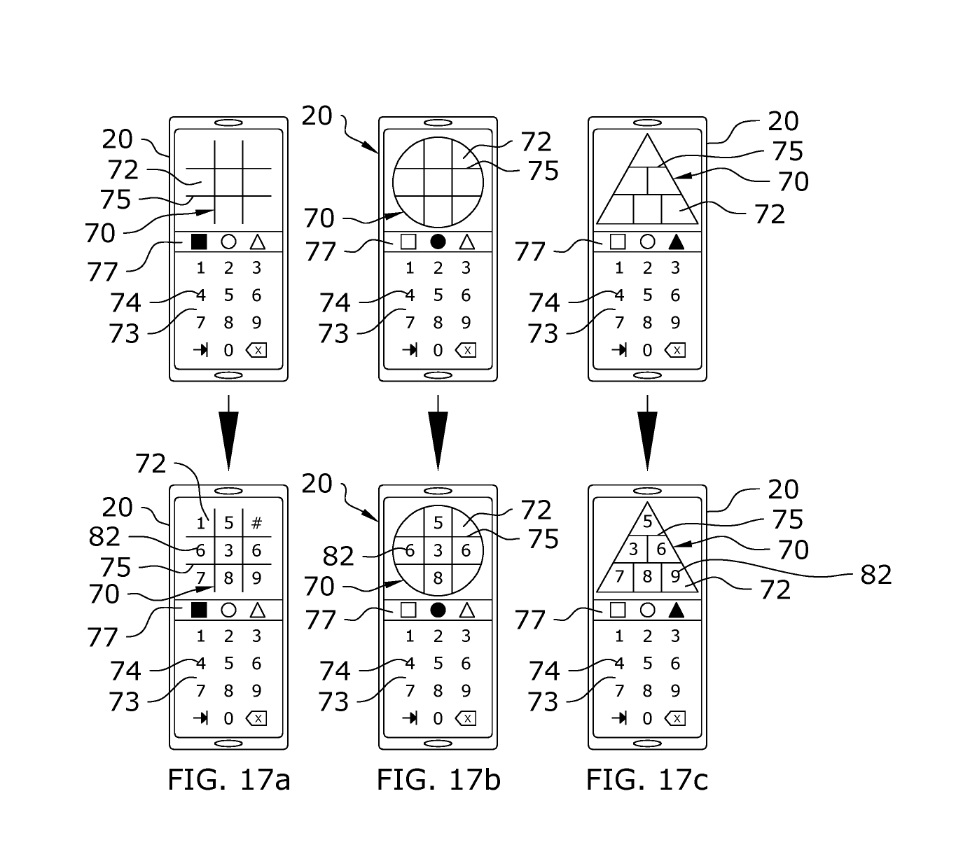

In some embodiments, the interface 70 may support different visual patterns 75 which may be selectively interchanged on the user device 20. FIGS. 17a-c and 18a-b illustrate an interface 70 which includes a pattern selector 77. The pattern selector 77 may be utilized to select a particular visual pattern 75 for the entry fields 72.

In the exemplary embodiment of FIGS. 17a-c, the pattern selector 77 includes options for a square, circle, or triangle shaped visual pattern 75. By selecting the square pattern selector 77 as shown in FIG. 17a, the interface 70 will display a square-shaped visual pattern 75 of entry fields 72. By selecting the circle pattern selector 77 as shown in FIG. 17b, the interface 70 will display a circular-shaped visual pattern 75 of entry fields 72. By selecting the triangle pattern selector 77 as shown in FIG. 17c, the interface 70 will display a triangular-shaped visual pattern 75 of entry fields 72.

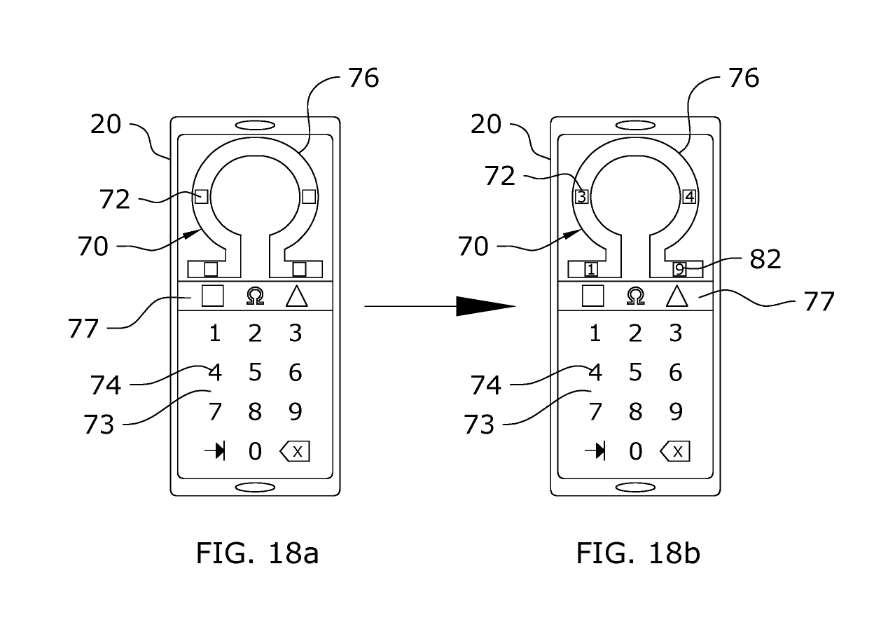

These exemplary views are in no way limiting, and it should be appreciated that any type of visual pattern 75 may be supported by the pattern selector 77. For example, the pattern selector 77 could include an option visualizing a company logo 76 which, upon being selected, will display a visual pattern 75 visualizing that company logo 76. FIGS. 18a-b illustrates an exemplary interface in which the visual pattern 75 of the entry fields 72 comprises a company logo 76 for a fictional “OMEGA CORP”. It should be appreciated that any company logo 76 could be incorporated into the interface 70, with the entry fields 72 being positioned within the visual pattern 75 of the company logo 76 such as shown in FIG. 18a-b.

Once the client application 22 is installed or communicated via the communication network 14 to the user device 20, the user may enter a code 80 having a particular visual arrangement using an interface 70 of the client application 22 and transmit a request with the code 80 having the particular visual arrangement to the central server 30. The central server 30 receives the code 80 having the particular visual arrangement, queries the database 32 for a destination associated with the code 80 having the particular visual arrangement and sends a reference to the destination to the client application 22. The client application 22 may request resources located at the destination and display a representation of the resources using the client application 22. In one embodiment, the client application 22 may prompt the user to open a web browser application of the user device 20 to display the representation of the resources.

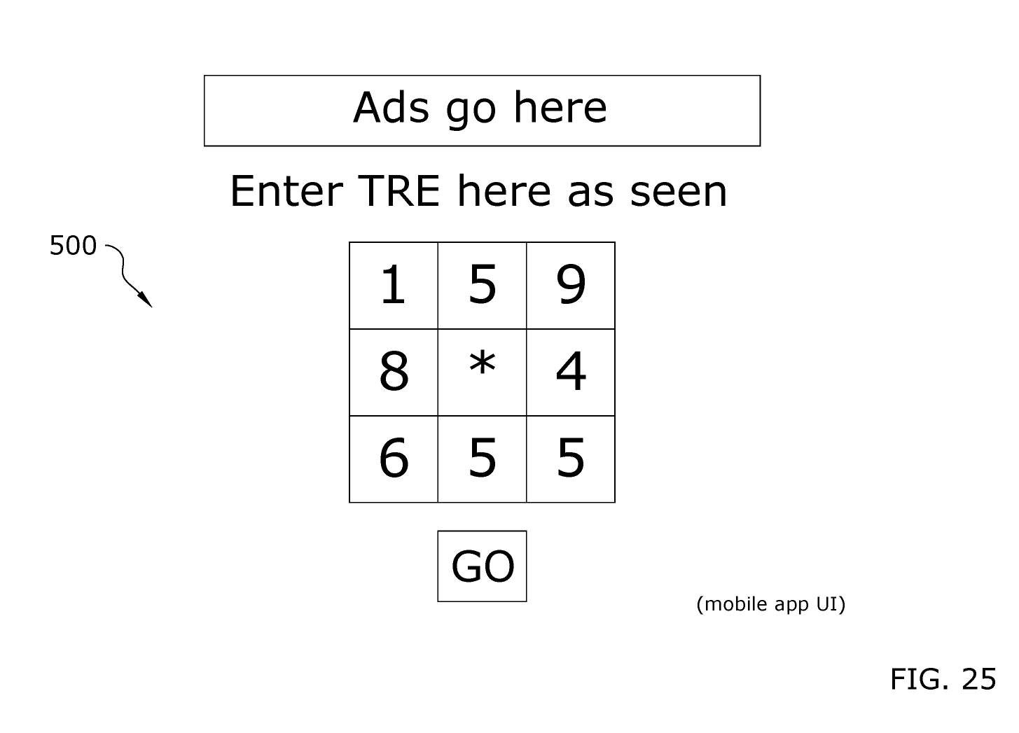

FIG. 25 illustrates another example user interface 500 displayed by the client application 22 of the user device 20 according to an example embodiment.

### D. Provider Application

In another embodiment, an administrator user may transmit a destination that is a reference to content 90 from the administrator application 42 of the administrator device 40 to the central server 30. The central server 30 receives the reference to the destination, e.g., a URL, generates a code 80 having a particular visual arrangement, associates the code 80 having the particular visual arrangement with the reference to the destination, and stores the reference to the destination and a representation of the code 80 having the particular visual arrangement in the database 32. An administrator user may modify the reference to content 90, e.g., change the destination from a first URL to a second URL, or change the specific content 90 to be transmitted to the user device 20, without having to regenerate the code 80 having the particular visual arrangement. Each administrator user may have a list of one or more references to destinations. Each reference to a destination in the list may have an associated code 80 having a particular visual arrangement.

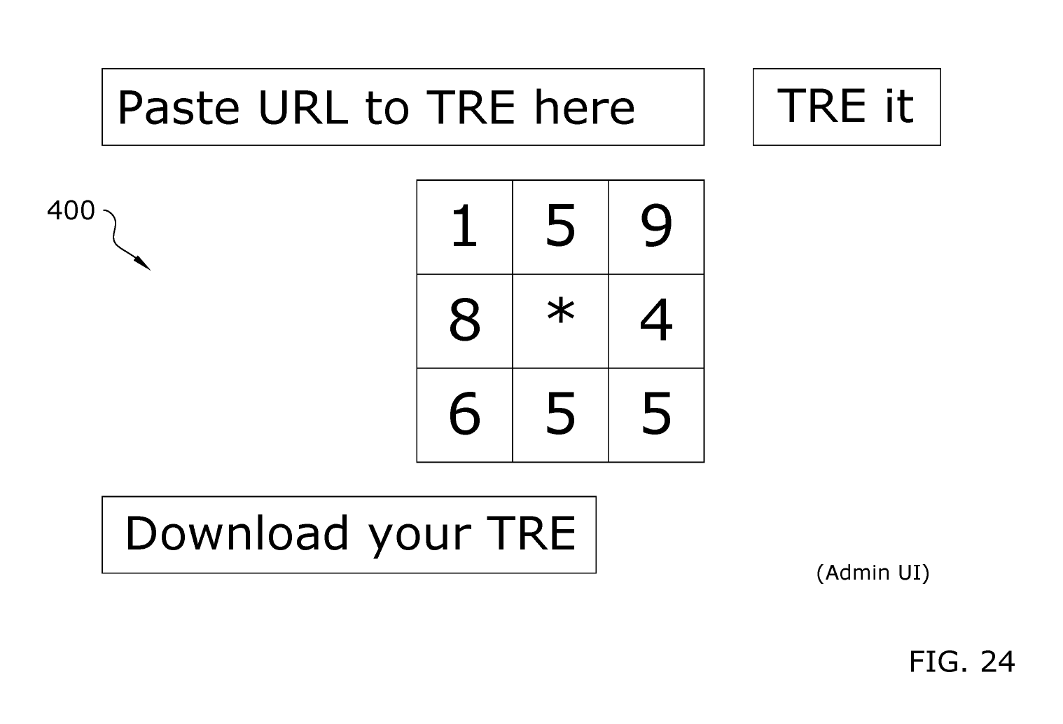

FIG. 24 illustrates an example administrator interface 400 displayed by the administrator application 42 of the administrator computing device 40 according to an example embodiment.

In an additional embodiment, the administrator user may create a destination having a URL using a site builder provided by the central server 30 and/or another server. The administrator user may use the site builder to add content to the destination including Facebook content, Twitter content, Pinterest content, Instagram content, coupon content, advertisement content, and other content. After creating the destination using the site builder, the site builder provides the URL associated with the destination to the central server 30. The central server 30 receives the URL, generates a code 80 having a particular visual arrangement, associates the code 80 having the particular visual arrangement with the URL, and stores the URL or a reference to the URL, and a representation of the code 80 having the particular visual arrangement in the database 32.

### E. Codes

The methods and systems described herein utilize a code 80 which is related to specific content 90. The code 80 is entered by the user and transmitted to the central server 30. The central server 30 will identify the code 80 and the content 90 related to that code 80. The central server 30 will then either transmit content 90 directly to the user device 20, direct another system such as a content server 50 to transmit content 90 to the user device 20, or provide a destination to the user device 20 to be directed to for the content 90.

Various types of codes 80 may be utilized with the methods and systems described herein. The exemplary descriptions and figures herein are merely exemplary, and it should be appreciated that different codes 80 may be utilized than those which are illustrated herein. The scope of the present invention should not be limited in any manner with respect to the type of code 80 being entered in the user device 20.

The code 80 will generally comprise at least one element 82 having a particular visual arrangement. Any type of element 82 may be utilized for the code, including numbers, symbols, characters, letters, emojis, representations of items such as food or money, or the like. If the content 90 is related to food, the code 80 may comprise different food items in a particular visual arrangement. In some cases, the code 80 may be a phone number which is entered into the user device 20.

As an example, there are eight billion possible codes 80 having a particular visual arrangement. A nine-character code 80 having a particular visual arrangement using ten digits (0, 1, 2, 3, 4, 5, 6, 7, 8, 9) includes one billion possibilities. A nine-character code 80 having a particular visual arrangement including the “*” character using ten digits includes nine hundred million possibilities. A nine-character code 80 having a particular visual arrangement including the “#” character using ten digits includes nine hundred million possibilities. A nine-character code 80 having a particular visual arrangement including the “*” and the “#” characters using ten digits includes 5.12 billion possibilities.

The visual arrangement of the code 80 may vary widely in different embodiments. In some embodiments, the visual arrangement may comprise an array such as a multi-dimensional array of the elements 82. In some embodiments, the visual arrangement may comprise a matrix such as a 3×3 matrix of elements 82. Various other visual arrangements may be utilized, and the descriptions and exemplary figures herein should not be construed as limiting with respect to available visual arrangements for the elements 82 of the code 80.

The code 80 may comprise a specified manner, including but not limited to positioning of each element 82, orientation of the elements 82, and/or sequence of entry of each element 82, in which the elements 82 are entered in to the entry fields 72 of the interface 70. The specified manner may include information relating to what specific element 82 is to be entered into the interface 70. The specified manner may include information relating to which entry fields 72 the code 80 should be entered in. The specified manner may also comprise a specific shape which the code 80 is meant to represent. Thus, the specified manner may comprise the visual arrangement 82 of the code 80.

For example, the specified manner of a code 80 may comprise specific entry fields 72 into which specific elements 82 must be entered. The specified manner may comprise which of the entry fields 72 to enter code 80 in. The specified manner may also comprise a sequence by which the code 80 is entered into the interface 70. The specified manner may also comprise one or more of the entry fields 72 into which at least one element 82 of the code 80 is entered.

In some embodiments, the code 80 may require that certain elements 82 be entered into certain entry fields 72 of the interface 70. The placement of elements 82 within an interface 70 will generally be part of the specified manner for entry of each code 80. For example, the code 80 may require that an element 82 be placed in the upper-right entry field 72 of an interface 70. In such an embodiment, if that element 82 is placed in a different entry field 72, such as the lower-right entry field 72, the code 80 will be considered invalid or a different content 90 will be delivered.

As an example of the benefit of this approach, a three-element code 80 will have far more applications. In the case of a three-element code 80, without positioning requirements relating to which entry fields 72 to enter the elements 82 of the code 80 in, the three-element code 80 may only be related to one specific type of content 90 which is delivered to the user device 20 regardless of positioning of the elements 72. If positioning is required, that same three-element code 80 may be used for at least eight types of content 90, as there are at least eight different locations that the three-element code 80 could be entered in a nine-entry field 72 interface 70.

Turning to another example of positioning of elements 82 being incorporated into a code 80, we can consider a code 80 which comprises only a single element 82. In such a case, the single element 82 could only represent a single type of content 90 if positioning is not taken into account. If positioning is taken into account, that same single element 82 could represent the same number of types of content 90 as there are entry fields 72 in the interface 70. For example, entry of the single element 82 into a first entry field 72 would retrieve different content 90 than entry of the same single element 82 into a second entry field 72.

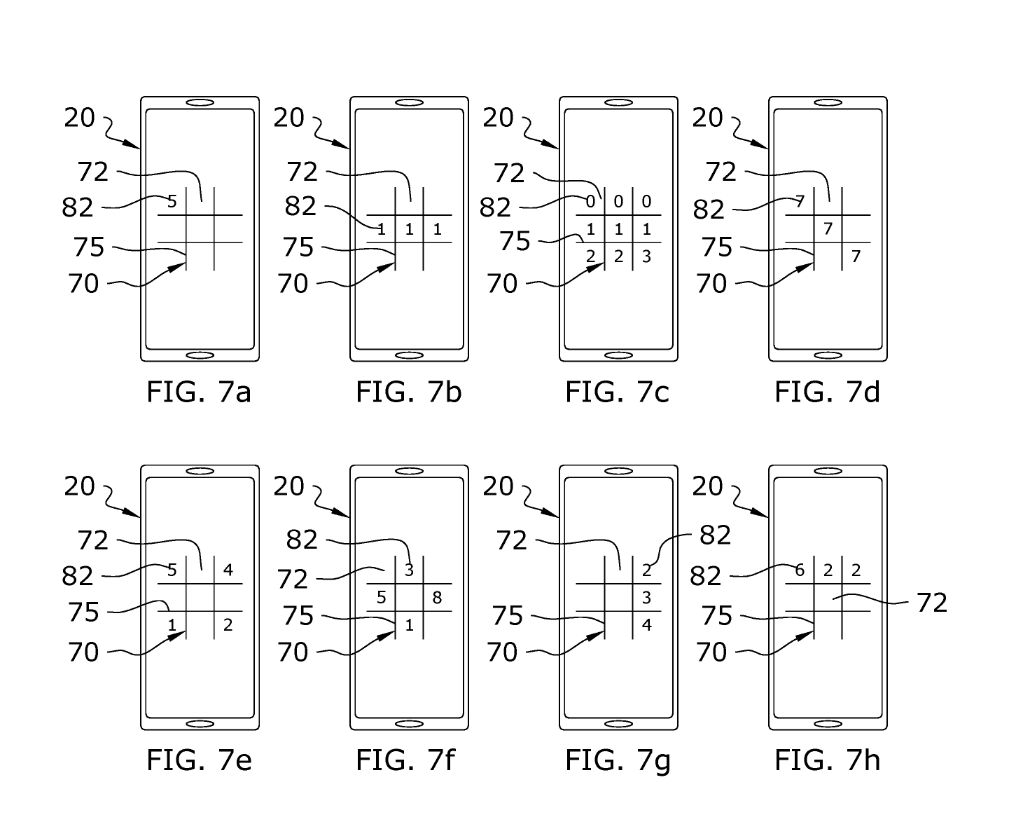

FIGS. 7a-h and 8a-f illustrate different exemplary codes 80, each having a particular visual arrangement. FIG. 7a illustrates a code 80 in which a single element 82 has been entered into a single entry field 72 of the interface 70. With respect to the code 80 shown in FIG. 7a, the code 80 may have included the specified manner that the element 82 be entered in the upper-left entry field 72. In embodiments in which positioning of elements 82 is taken into account, the entry of the same element 82 in another entry field 72, such as the center entry field 72, would have either retrieved different content 90 or led to a notification of an invalid code 80.

FIG. 7b illustrates a code 80 in which three elements 82 are arranged in a horizontal line across the interface 70. Such a code 80 may have included the specified manner that the elements 82 of the code 80 be entered in the second row of entry fields 72 of the interface 70. In embodiments in which positioning of elements 82 is taken into account, the entry of the same three elements 82 in different entry fields 72 of the interface 70, such as oriented vertically or positioned in the lower row of the interface 70, would either retrieve different content 90 or lead to an invalid code 80 notification.

FIG. 7c illustrates a code 80 in which nine elements 82 are arranged in a 3×3 matrix. Notably, with this code 80, all of the entry fields 72 of the interface 70 are filled with elements 82. Nevertheless, this code 80 may also include a specified manner which indicates which entry field 72 each of the code's 80 elements is to be entered into.

FIG. 7d illustrates a code 80 in which three elements 82 are arranged diagonally. In this example embodiment, the specified manner of the code 80 would indicate that the elements 82 should be arranged diagonally from the upper-left entry field 72 to the lower-right entry field 72. If the specified manner were ignored by, for example arranging the same elements 82 diagonally from the upper-right entry field 72 to the lower-left entry field 72, the central server 30 would either transmit a different content 90 or an invalid code 80 notification.

FIG. 7e illustrates a code 80 in which four elements 82 are arranged on the corner entry fields 72 of the interface 70. In this embodiment, the specified manner would have indicated that the outer corners of the interface 70 should be filled in with the elements 82 of the code 80. If the elements 82 were entered in a manner other than specified, then different content 90 or an invalid code 80 notification would be transmitted instead.

FIG. 7f illustrates a code 80 in which four elements 82 are arranged to form a cross pattern. In this embodiment, the specified manner would have indicated the entry fields 72 of the interface 70 in which to place each element 82 of the code 80. Failing to enter the code 80 in the specified manner would either retrieve different content 90 or return an invalid code 80 notification.

FIG. 7g illustrates a code 80 in which three elements 82 are arranged vertically. The specified manner would have indicated that the three elements 82 of this code 80 should be oriented vertically across the right column of the interface 70. Placement of the same three elements 82 in different entry fields 72 by ignoring the specified manner would result in different content 90 being transmitted or an invalid code 80 notification.

FIG. 7h illustrates a code 80 in which three elements 82 are arranged horizontally across the top of the interface 70. The specified manner would have indicated that the three elements 82 of this code 80 should be oriented horizontally across the top row of entry fields 72. Entry in a manner other than what was specified, such as by entering the same three elements 82 across the bottom row of entry fields 72, would result in different content 90 being transmitted or an invalid code 80 notification.

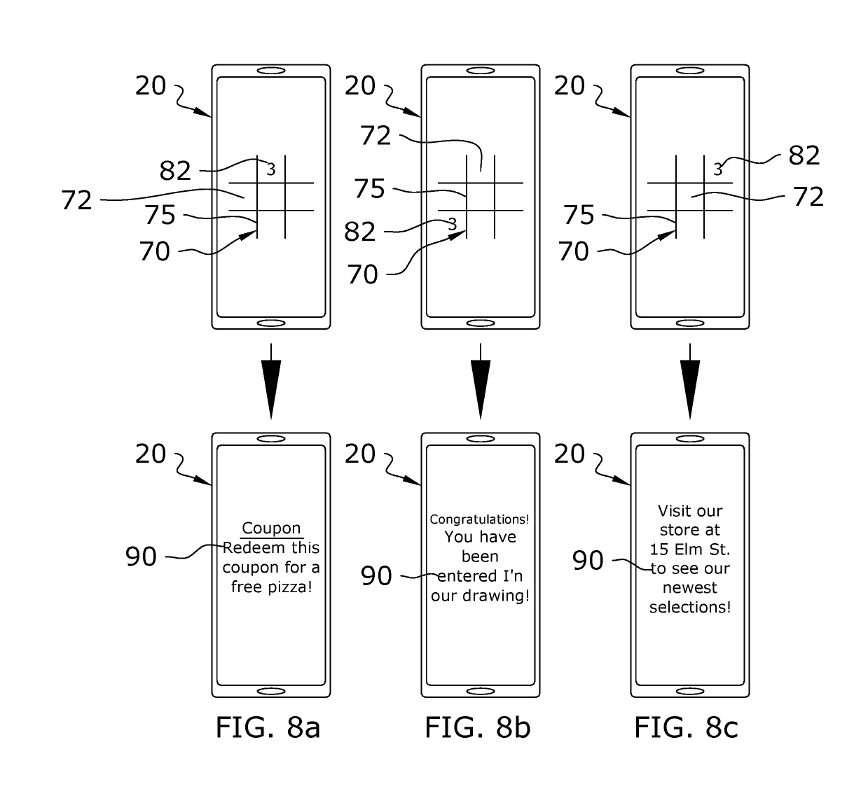

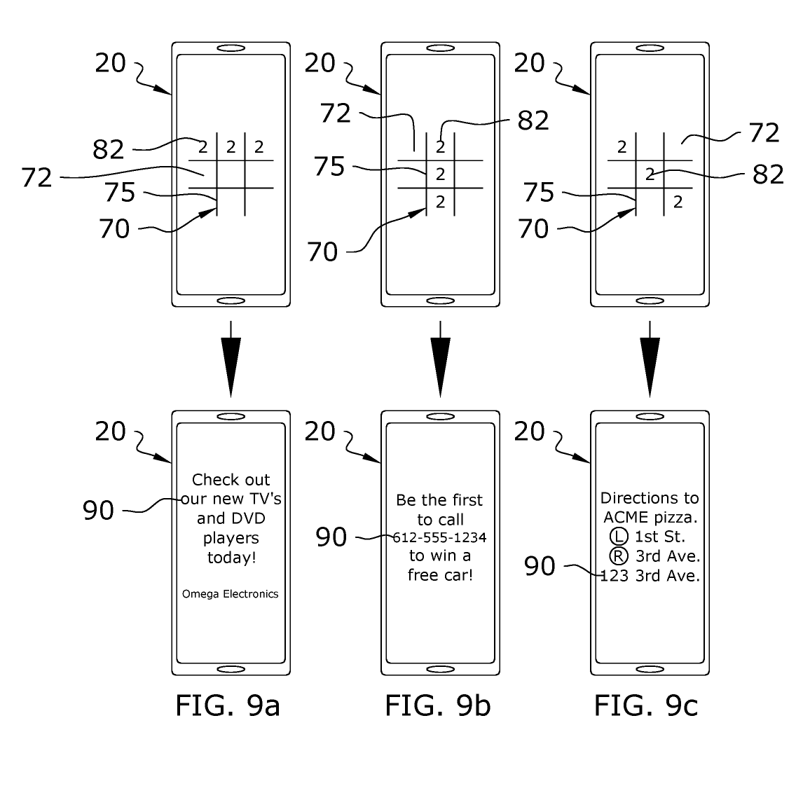

FIGS. 8 and 9 illustrate how the specified manner for entering a code 80, including the positioning and/or orientation of each element 82 of the code 80 in a specified entry field 72 of the interface 70, can allow for the same code 80 to be related to different types of content 90.

FIGS. 8a-c illustrate how the positioning of each element 82 of a code 80 can be used to receive different types of content 90. FIG. 8a illustrates a code 80 entered into an interface 70 in a first specified manner. In FIG. 8a, an element 82 comprising the number three has been entered in the top-center entry field 72 of a matrix-shaped interface 70. After transmitting the code 80 in the first specified manner, the user device 20 is illustrated receiving a first type of content 90 comprising a coupon.

FIG. 8b illustrates the same code 80 entered into the same interface 70 in a second specified manner. In FIG. 8b, the same element 82 comprising the number three has been entered in the lower-left entry field 72 of the same matrix-shaped interface 70. After transmitting the code 80 in the second specified manner, the user device 20 is illustrated receiving a second type of content 90 comprising an entry in a drawing.

FIG. 8c illustrates the same code 80 entered into the same interface 70 in a third specified manner. In FIG. 8c, the same element 82 comprising the number three has been entered in the top-right entry field 72 of the same matrix-shaped interface 70. After transmitting the code 80 in the third specified manner, the user device 20 is illustrated receiving a third type of content 90 comprising an advertisement.

FIGS. 9a-c illustrate how orientation of elements 82 of a code 80 can be used to receive different types of content 90. In FIG. 9a, a code 80 comprising three elements 82 has been entered into an interface 70 in a first specified manner. More specifically, the code 80 has been entered in a horizontal orientation into the top row of entry fields 72 of a matrix-shaped interface 70. After transmitting the code 80 in the first specified manner, the user device 20 is illustrated receiving a first type of content 90 comprising an advertisement to visit a store.

FIG. 9b illustrates the same code 80 comprising the same three elements 82 entered into an interface in a second specified manner. In FIG. 9b, the code 80 has been entered in a vertical orientation across the center column of a matrix-shaped interface 70. After transmitting the code 80 in the second specified manner, the user device 20 is illustrated receiving a second type of content 90 comprising an advertisement to enter a drawing.

FIG. 9c illustrates the same code 80 comprising the same three elements 82 entered into an interface in a third specified manner. In FIG. 9c, the code 80 has been entered in a diagonal orientation from the upper-left entry field 72 to the lower-right entry field 72 of a matrix-shaped interface 70. After transmitting the code 80 in the third specified manner, the user device 20 is illustrated receiving a third type of content 90 comprising directions to a store.

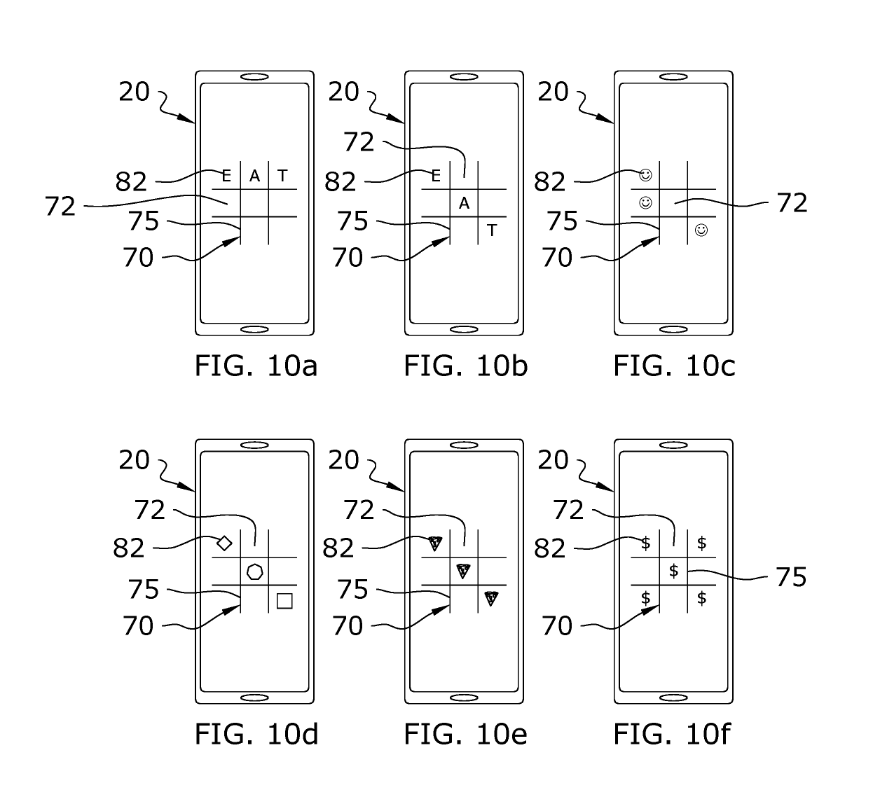

FIGS. 10a-f illustrate codes 80 which utilize elements 82 that are not comprised of numbers. FIGS. 10a and 10b illustrate a code 80 in which the elements 82 are letters arranged to spell a word having different visual arrangements. FIG. 10c illustrates a code 80 in which the elements 82 are smiley-faces in a visual arrangement. FIG. 10d illustrates a code 80 in which elements 82 are shapes in a visual arrangement. FIG. 10e illustrates a code 80 in which elements 82 comprise representations of pizza slices in a visual arrangement. FIG. 10f illustrates a code 80 in which elements 82 comprise dollar symbols in a visual arrangement. These exemplary views are in no way intended to be limiting.

According to an example embodiment, a reference to a destination or content, e.g., a URL, may be converted into a code of numbers, letters (uppercase and lowercase), and symbols by the code generation application 34. When a URL is “converted” into a code of numbers, the code generation application 34 associates the URL with the code 80, e.g., a code 80 having a particular visual arrangement. The code 80 may be presented in a particular visual arrangement. The particular visual arrangement may be an identifiable geometric shape (e.g., cube, circle, etc.). An example of a code 80 having a particular visual arrangement is shown in FIGS. 7-10. As an example, the URL may be converted into a 3×3 matrix having nine characters including all ten digits (0, 1, 2, 3, 4, 5, 6, 7, 8, and 9), the “*” character, and the “#” character that are selectable by telephone devices and computing devices having the QWERTY keyboard. Elements 82 in the code 80 may be repeated and according to an example embodiment, a position of an element 82 in the code 80 matters.

It should be appreciated that any type of content 90 may be utilized in combination with the methods and systems described herein. Content 90 could comprise anything that would be transmitted to the user device 20 by the central server 30 or content server 50. By way of example and without limitation, content 90 could comprise a URL web address, an FTP address, advertisements including audio and/or video, contest rules, coupons, or the like.

### F. Operation of Preferred Embodiment

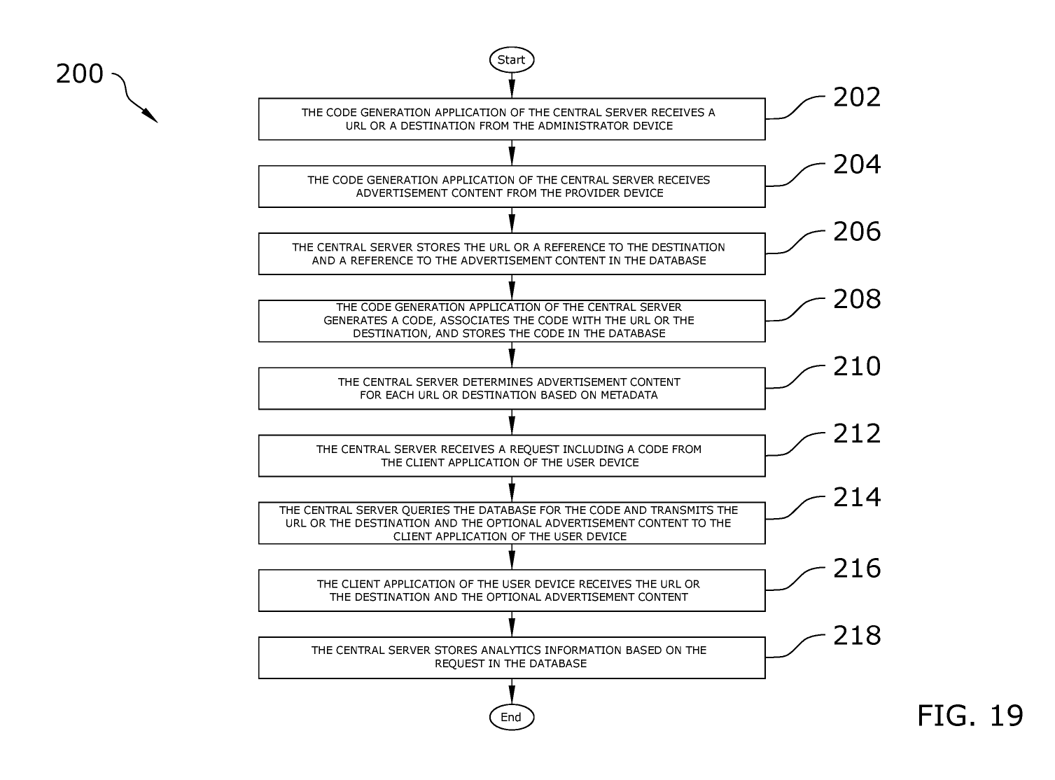

FIG. 19 illustrates a flowchart of an exemplary process for distributing content via the content distribution system 10 according to an example embodiment. The process 200 shown in FIG. 2 begins in step 202. In step 202, the code generation application 34 of the central server 30 receives a destination that is a reference to content 90, e.g., a URL or a destination page created using the site builder, from the administrator computing device 40. In step 204, the generation application 138 of the central server 30 receives advertisement content 90 or information from the provider device 60. In step 206, the central server 30 stores the reference to the content 90 and a reference to the advertisement content 90 in the database 32. In step 208, the generation application 138 of the central server 30 generates a code 80 having a particular visual arrangement, associates the code 80 having the particular visual arrangement with the reference to the content, and stores a representation of the code 80 having the particular visual arrangement in the database 32. In step 210, the central server 30 determines advertisement content 90 for each destination based on metadata associated with each reference to content 90. In step 212, the central server 30 receives a request including a code 80 having a particular visual arrangement from the client application 22 of the user device 20. In step 214, the central server 30 queries the database 32 for the code 80 having the particular visual arrangement, determines a destination associated with the code 80 having the particular arrangement, and transmits the destination, e.g., a URL, to the client application 22 of the user device 20. Optionally, the central server 30 may transmit advertisement content 90 associated with the destination to the client application 22 of the user device 20. In step 216, the client application 22 of the user device 20 receives the destination and the optional advertisement content 90. In step 218, the central server 30 stores analytic information based on the request in the database 32.

Turning to a more descriptive method of distributing content, a code 80 is first generated by the central server 30 that relates to specific content 90. The code 80 may be generated in response to a provider request. In such a case, a provider device 60 running a provider application 62 will display an interface in which a provider may transmit content 90 as in FIG. 19 or a link to content 90 as in FIG. 18 to the central server 30.

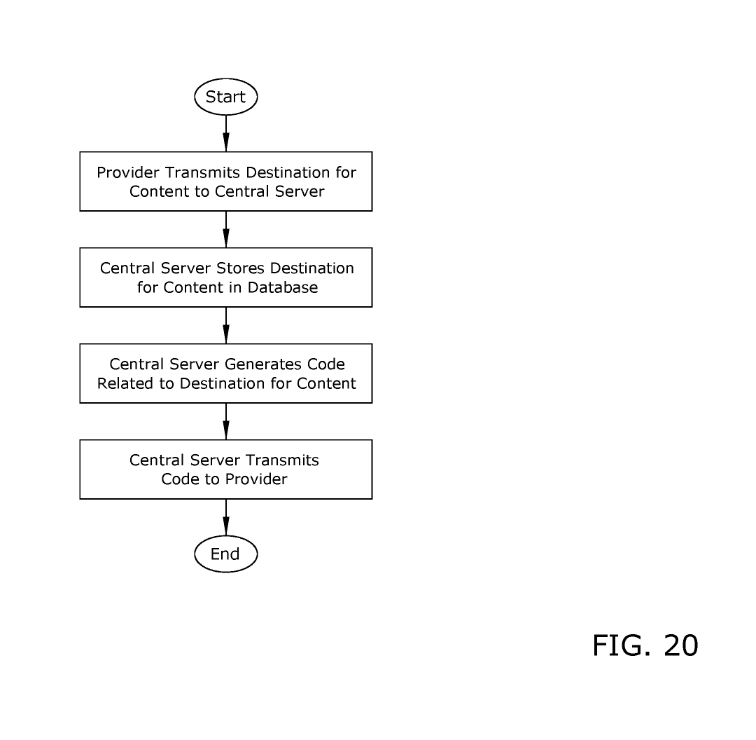

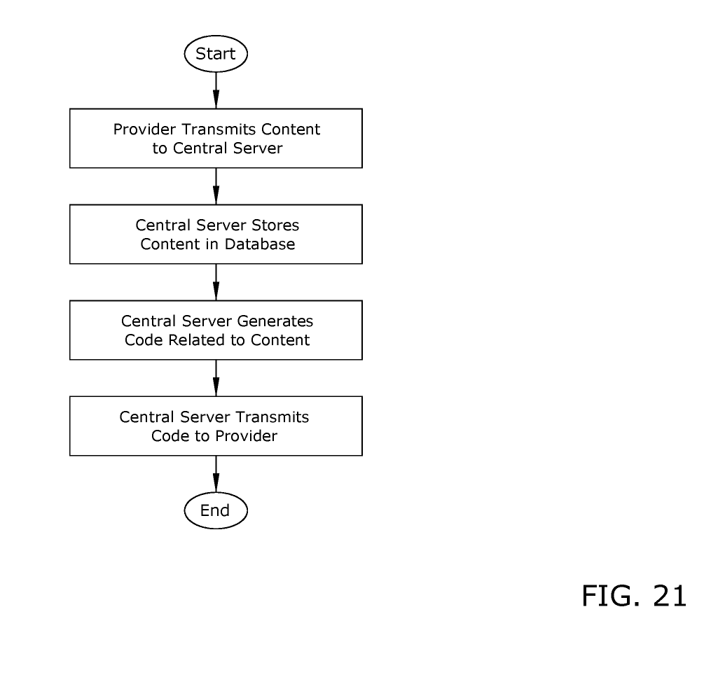

As illustrated in FIGS. 20 and 21, upon receipt of the content 90, the central server 30 will generate a code 80 and store that code 80 in its database 32 for future reference. The code 80 will also be transmitted to the provider so that the provider may display the code 80 to users for entry into their user devices 20. If the provider wishes to change the content 90 or change the code 80, an administrator device 40 running an administrator application 42 may be utilized to connect to the central server 30 and direct the central server 30 to make the requested modifications. In some embodiments, the administrator device 40 and the provider device 60 may be the same.

The code 80 may comprise a specified manner in which the elements 82 of the code 80 are to be entered into the entry fields 72 of the interface 70. The specified manner may comprise specific entry fields 72 of the interface 70 into which certain elements 82 of the code 80 are to be entered. In some embodiments, the positioning of the elements 82 of the code 80 within certain entry fields 72 of the interface 70 will be necessary for proper entry of a code 80. In other embodiments, the positioning of the elements 82 of the code 80 within certain entry fields 72 of the interface 70 is not necessary for proper entry of a code 80.

In one embodiment, the specified manner comprises a first entry field 72 in which to enter a first element 82 of the code 80 and a second entry field 72 in which to enter a second element 82 of the code 80. The user may then enter the first element 82 of the code 80 into the first entry field 72 of the plurality of entry fields 72 and entering the second element 82 of the code 80 into the second entry field 72 of the plurality of entry fields 72.

Different codes 80 may be more desirable than other codes 80. For example, a simpler code 80, such as requiring only a single element 82 to be entered into a single, specific entry field 72 may be more desirable to a provider than more complex codes 80. Thus, the operator of the system described herein may charge a premium for such simpler codes 80, or specific codes 80 that relate in some way to the provider (i.e., codes 80 including elements 82 comprised of hamburgers for a hamburger restaurant).

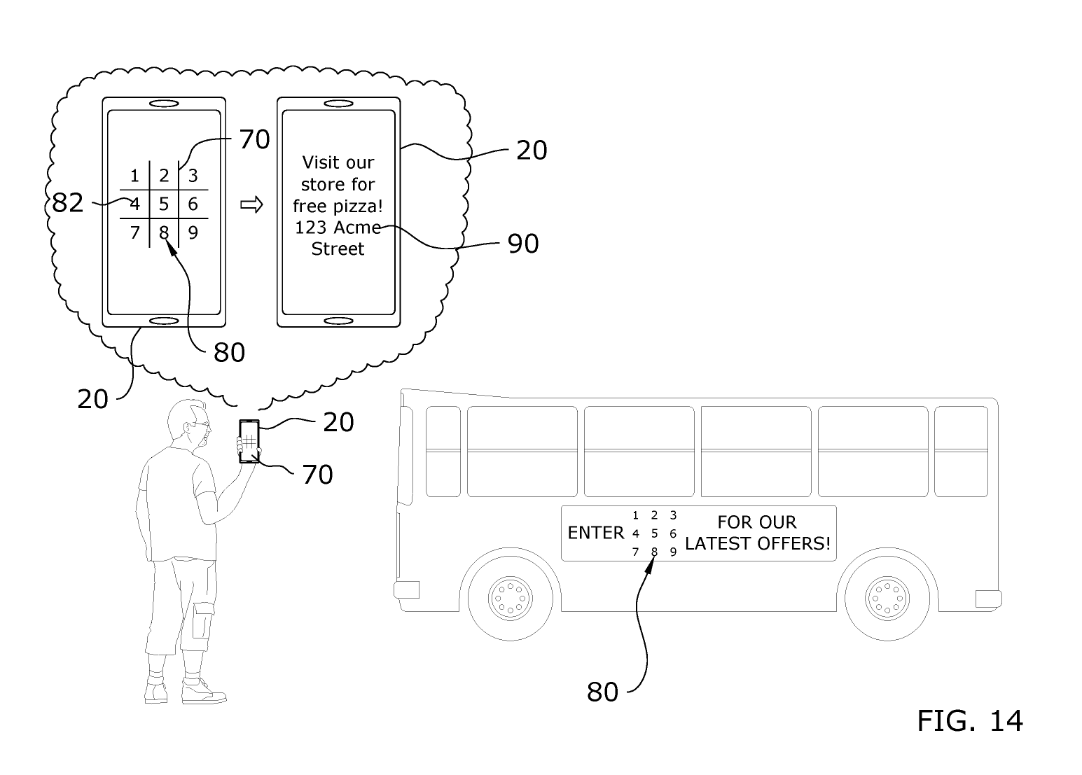

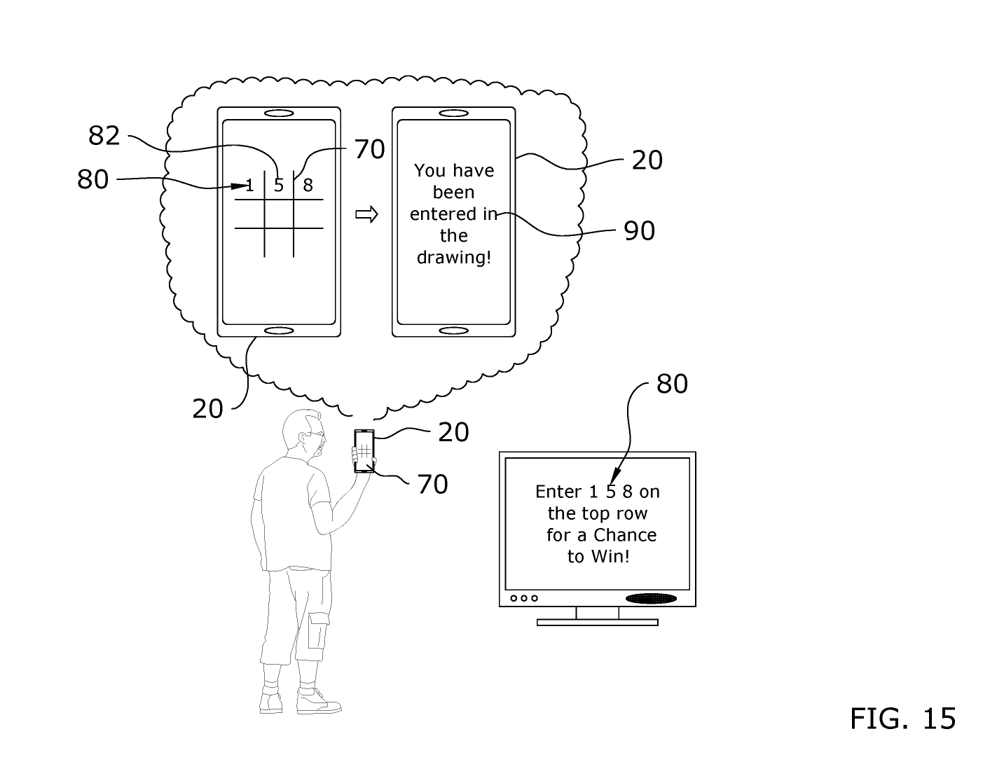

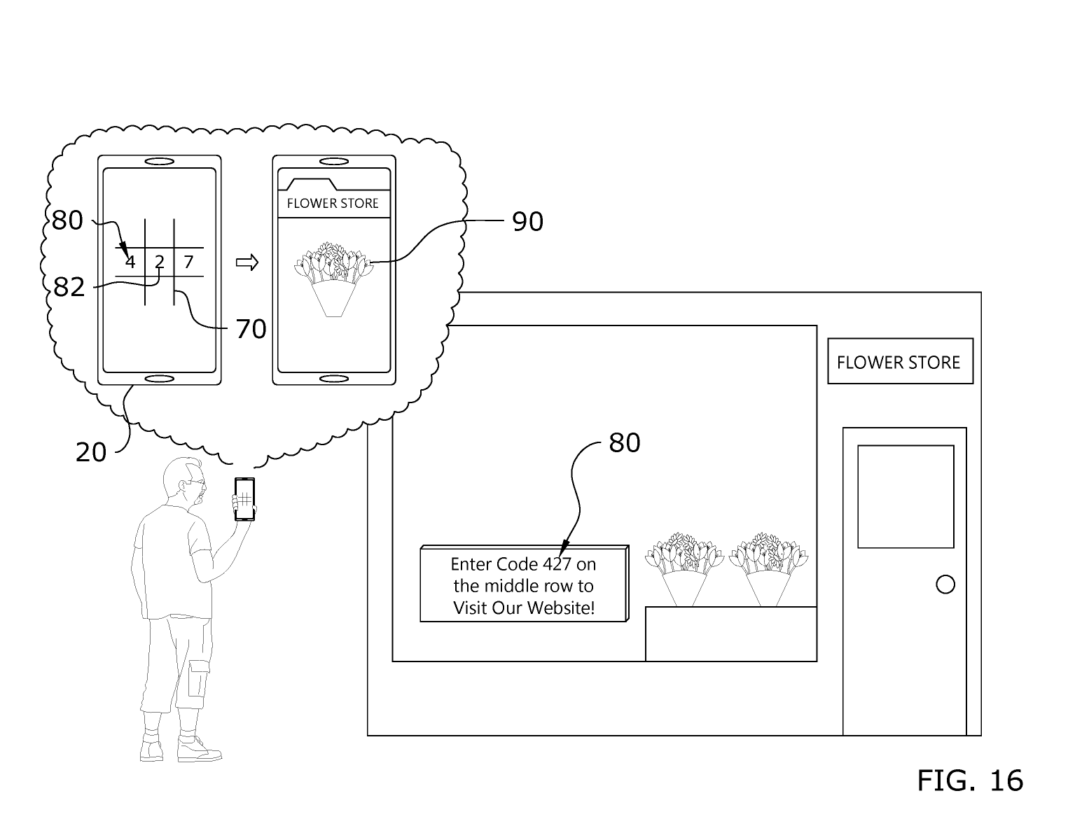

Once a code 80 has been generated to relate to specific content 90, the code 80 may be displayed in various manners. FIG. 14 illustrates a code 80 on an advertisement on the side of a bus. FIG. 15 illustrates a code 80 being displayed on a television set to a user. FIG. 16 illustrates a code 80 in a store window to be viewed by passing users. These are merely exemplary methods of displaying the code 80 to users, and it should be appreciated that various other methods may be utilized to advertise the code 80 to users.

Upon viewing a code 80 related to content 90 that a user desires to receive, the user will first activate the user device 20. The client application 22 may be executed directly on the user device 20. Alternatively, the user device 20 may connect to a website or the like, with the client application 22 being executed remotely and its functionalities communicated to the user device 20 via the communication network 14. In either case, the user device 20 will display the interface 70 into which the user may enter the code 80.

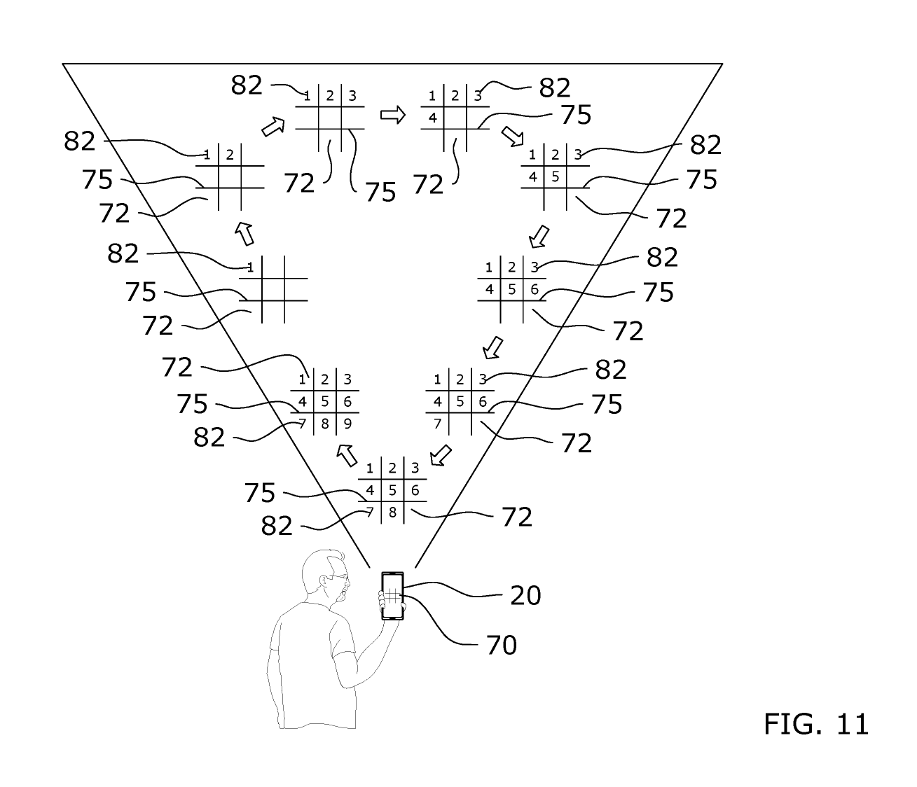

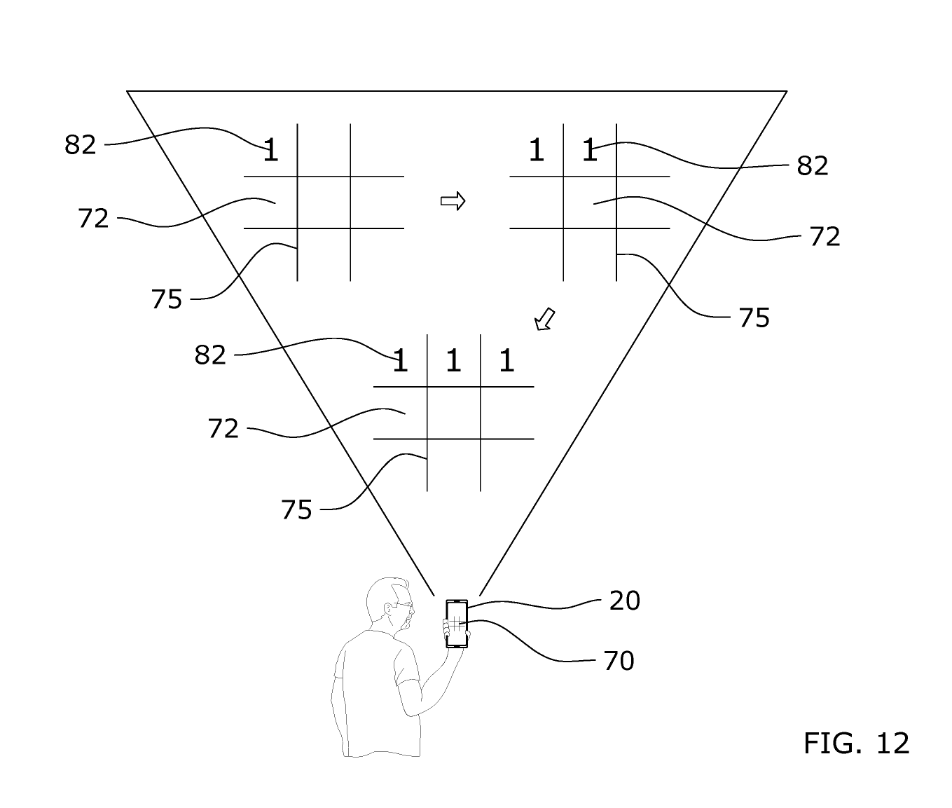

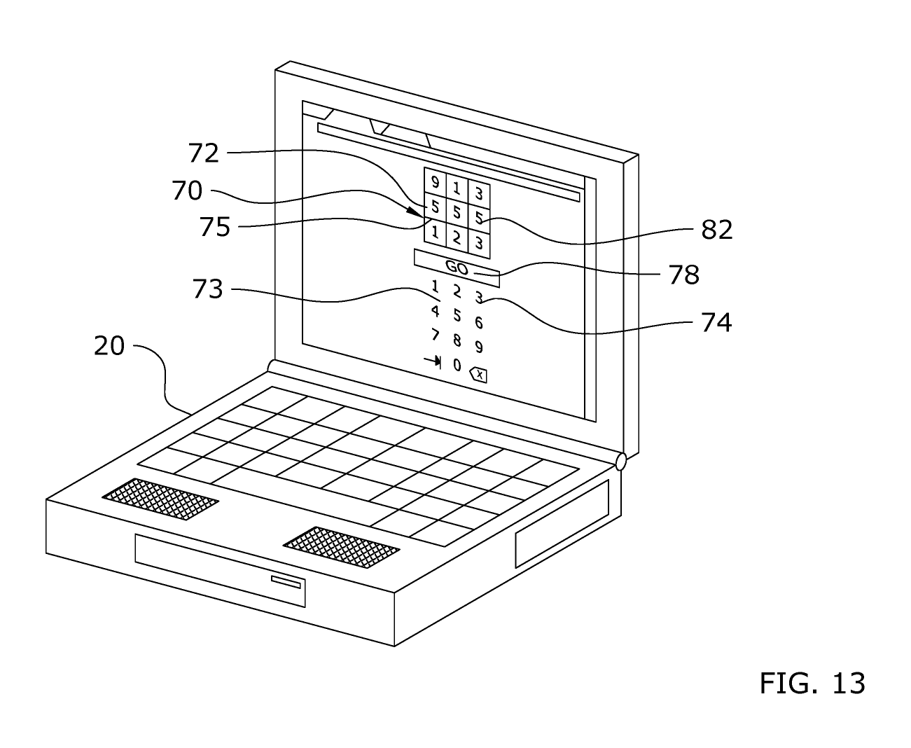

FIGS. 11-12 illustrate different entries of codes 80 in a user device 20. The user will utilize the keypad 73, an input device, or voice commands to enter the elements 82 of the code 80 into the entry fields 72 of the interface 70. The code 80 will generally specify the manner in which the code 80 is entered, including which elements 82 are to be entered into specified entry fields 72 of the interface 70. Upon completion of entering the code 80, the user may select the button 78 to indicate that the code 80 has been entered. Alternatively, the user device 20 may automatically recognize the code 80 upon its entry completion and automatically communicate the code 80 to the central server 30. If the code 80 being entered relates to a telephone number, the user device 20 may recognize the same and prompt the user to confirm that a telephone number is being entered as the code 80.

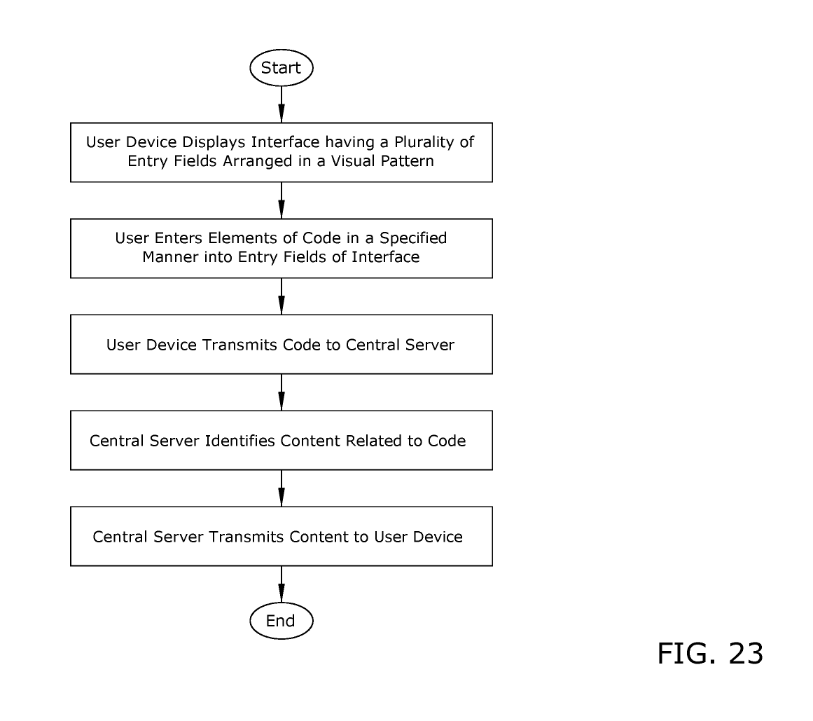

As illustrated in FIGS. 22 and 23, upon entry of the code 80, the user device 20 will communicate the code 80 to the central server 30. The central server 30 will query its database 32 to determine if the code 80 is present. If the code 80 is not recognized, the central server 30 will communicate an error to the user device 20 and invite the user to check the code 80 and enter it again. If the code 80 is recognized, then the central server 30 will either directly transmit content 90 to be displayed on the user device 20, transmit a link to a content server 50 storing the content 90 to be retrieved by the user device 20, or communicate to the content server 50 and direct the content server 50 to transmit the content 90 to the user device 20.

In the first case, the central server 30 will have previously stored the content 90 in its memory 36. Upon receiving and recognizing the code 80, the central server 30 will communicate the stored content 90 from its memory 36 to the user device 20 via the communication network 14.

In the second case, the central server 30 will have previously associated a destination, such as a webpage or the like, which stores the content 90. The central server 30 will transmit the destination, typically a link to connect to a content server 50 such as a web server 52, to the user device 20. The user may select the link to instruct the user device 20 to communicate with the content server 50 and visit the destination.

In the third case, the central server 30 will direct the user device 20 to connect directly with the content server 50. Content 90 stored in the memory 54 of the content server 50 will be transmitted from the content server 50 to the user device 20, where it may be viewed by the user.

The description above includes example systems, methods, techniques, instruction sequences, and/or computer program products that embody techniques of the present disclosure. However, it is understood that the described disclosure may be practiced without these specific details.

It is believed that the present disclosure and many of its attendant advantages will be understood by the foregoing description, and it will be apparent that various changes may be made in the form, construction and arrangement of the components without departing from the disclosed subject matter or without sacrificing all of its material advantages. The form described is merely explanatory, and it is the intention of the following claims to encompass and include such changes.

Unless otherwise defined, all technical and scientific terms used herein have the same meaning as commonly understood by one of ordinary skill in the art to which this invention belongs. Although methods and materials similar to or equivalent to those described herein can be used in the practice or testing of the Content Distribution System, suitable methods and materials are described above. All publications, patent applications, patents, and other references mentioned herein are incorporated by reference in their entirety to the extent allowed by applicable law and regulations. The content distribution system may be embodied in other specific forms without departing from the spirit or essential attributes thereof, and it is therefore desired that the present embodiment be considered in all respects as illustrative and not restrictive. Any headings utilized within the description are for convenience only and have no legal or limiting effect.

What is claimed is:

1. A method of transmitting content from a central server to a user device, comprising:
receiving a code from the user device by the central server, the code comprising at least one element having a visual arrangement;
identifying content related to the code received from the user device by the central server; and
transmitting the content related to the code from the central server to the user device.

2. The method of claim 1, wherein the visual arrangement comprises an array.

3. The method of claim 2, wherein the visual arrangement comprises a matrix.

4. The method of claim 3, wherein the visual arrangement comprises a 3×3 matrix.

5. The method of claim 1, wherein the at least one element is selected from the group consisting of letters, numbers, and symbols.

6. The method of claim 1, wherein the at least one element of the code comprises a plurality of numbers.

7. The method of claim 6, wherein the plurality of numbers are arranged in a matrix.

8. The method of claim 1, wherein the at least one element comprises at least one symbol related to the content.

9. The method of claim 1, wherein the user device comprises a mobile phone.

10. A method of receiving content on a user device, comprising:
displaying an interface on the user device, the interface comprising a plurality of entry fields arranged in a visual pattern;
receiving a code comprising at least one element to be entered in the interface in a specified manner;
entering the code into the interface in the specified manner; and
receiving content related to the code on the user device.

11. The method of claim 10, wherein the specified manner comprises one or more of the plurality of entry fields into which the at least one element of the code is entered.

12. The method of claim 11, wherein the specified manner comprises a sequence by which the code is entered into the interface.

13. The method of claim 10, wherein the specified manner comprises which of the plurality of entry fields to enter the code.

14. The method of claim 13, wherein the specified manner comprises a first entry field of the plurality of entry fields to enter a first element of the code and a second entry field of the plurality of entry fields to enter a second element of the code.

15. The method of claim 14, further comprising the steps of entering the first element of the code into the first entry field of the plurality of entry fields and entering the second element of the code into the second entry field of the plurality of entry fields.

16. The method of claim 10, wherein the interface comprises a keypad comprising a plurality of entry elements.

17. The method of claim 10, wherein the interface comprises a company logo, wherein the at least one entry field is positioned within the company logo in the interface.

18. The method of claim 10, wherein the interface comprises a pattern selector.

19. The method of claim 18, further comprising the step of selecting the visual pattern of the plurality of entry fields with the pattern selector.

20. A method of transmitting content to a user device, comprising:
receiving content from a content provider to be transmitted to the user device;
generating a code related to the content, the code comprising at least one element having a particular visual arrangement;
receiving the code from a user device;
identifying the content related to the code received from the user device; and
transmitting the content to the user device.
